(19) United States
(12) Patent Application Publication
(10) Pub. No.: US 2019/0058193 A1
(43) Pub. Date: Feb. 21, 2019

(54) METHOD FOR PRODUCING LITHIUM-ION, SODIUM-ION AND POTASSIUM-ION BATTERIES WITH INCREASED SAFETY

(71) Applicant: River Road Research, Inc., Tonawanda, NY (US)

(72) Inventors: Radu Popa, Reseda, CA (US); Kenneth H. Nealson, South Pasadena, CA (US); Vily M. Cimpoiasu, Craiova (RO)

(21) Appl. No.: 15/766,210

(22) PCT Filed: Oct. 6, 2016
(86) PCT No.: PCT/US16/55646

§ 371 Date: Apr. 5, 2018

Related U.S. Application Data
(60) Provisional application No. 62/239,549, filed on Oct. 9, 2015.

(51) Int. Cl. H01M 4/60; H01M 10/42; H01M 10/0525; H01M 10/054; C09B 67/00

(52) U.S. Cl. CPC H01M 4/604; H01M 10/4235; H01M 2004/027; H01M 10/054; C09B 68/423; H01M 10/0525

(57) ABSTRACT

A method for producing lithiated pyomelanin (LPM), sodiated pyomelanin (SPM) and potassiated pyomelanin (PPM) is provided. A method is also provided for improving the safety of lithium-ion (Li-ion), sodium-ion (Na-ion) and potassium-ion (K-ion) batteries. The method employs using LPM, SPM or PPM in the negative compartment (anode) of the batteries. These LPM Li-ion, SPM Na-ion and PPM K-ion batteries have decreased tendencies to overheat and/or explode.

### CROSS-REFERENCE TO RELATED APPLICATIONS

This application claims priority to and the benefit of co-pending U.S. provisional patent application Ser. No. 62/239,549, entitled Method for Producing Lithium-Ion Batteries with Increased Safety, filed Oct. 9, 2015, which is incorporated herein by reference in its entirety.

### 1. TECHNICAL FIELD

The present invention relates to methods for improving safety of lithium-ion, sodium-ion and potassium-ion batteries. The invention also relates to methods for producing lithiated pyomelanin (LPM), sodiated pyomelanin (SPM) and potassiated pyomelanin (PPM).

### 2. BACKGROUND

Electricity is, and will be for the foreseeable future, a major and versatile form of energy used by the human society. Other sources of energy are converted to electricity, and then electricity is distributed for a multitude of tasks. However, the storage of electricity and the use of stored electricity are fraught with problems:

(1) Some batteries are made with heavy metals and are expensive, toxic and non-renewable. While batteries made with heavy metals can be recycled, the process for recycling metals is expensive and is an environmental and health hazard.

(2) Not all batteries can be recharged, making recycling even more expensive.

(3) Many rechargeable batteries are prone to failure and can become unsafe, owing to chemical contaminants, fast discharge kinetics, overheating, and runaway reactions. In some batteries, including rechargeable lithium-ion (Li-ion) batteries, such failure may result in irreversible damage and explosion.

Two principal causes make Li-ion batteries unsafe. In the event of short circuit, of high power demand, or when batteries are submerged in water, the discharge current is much larger than the Maximum Discharge Current established by manufacturers based on heat dissipation capabilities and thermal sensitivity of battery materials. In Lithium-ion (Li-ion) batteries, the negative electrode reaction during discharge is:

LiₓC₆=xLi⁺+xe⁻+C₆

where: C6 represents conductive carbon substrate such as carbon microbeads or graphite.

During fast discharge, overheating, destruction of materials and battery deformation may occur and the electrode contents may come into contact with water. Alternatively, traces of water can be present due to fabrication defects or infiltration. The reaction between lithium metal and water is exothermic and change in volume occurs due to formation of dihydrogen gas:

2Li^{o}(s)+2H₂O=2LiOH(aq)+H₂(g)

The buildup of gas leads to further battery deformation, air and moisture leak from the outside, leading to a runaway reaction and eventually ignition of the hydrogen, which burns with oxygen from air.

Both of these problems stem from the fact that in the anode of most Li-ion batteries, lithium is in elemental form adsorbed on the surface of conductive carbon, rather than bound via a strong bond in a chemical substance. As a result, the negative electrode discharge reaction is fast and unsafe. Because in most Li-ion batteries poor regulation of the anode discharge reaction exists, these batteries discharge very fast when demand of electricity surpasses the Maximum Discharge Current or when external resistance becomes very low, with destructive consequences.

It has been proposed that adding polymer-carbon composites coated with polypyrrole can increase the safety of Li-ion batteries by adsorbing and desorbing protons when batteries are operated (U.S. Pat. No. 6,274,268 B1). It has also been proposed that the safety of Li-ion batteries can be improved by adding an organic carbonyl compound wherein carbonyl in the core are reduced and coordinated to metal ions (WO 2014169122 A1).

Drawbacks of using polypyrroles in Li-ion batteries are increased costs (polypyrrole is more expensive than graphite) and decreased power storage (owing to an increase in internal resistance). In certain cases (such as airplane batteries), however, such drawbacks are negligible relative to the benefits of increased safety.

Quinones and polyquinones in general, and melanins in particular, make good battery materials (Pirnat et al., 2012; Yao et al., 2012; Nawar et al. 2013; Zhao et al., 2013; Zou et al., 2014; US 20030118877 A1). Quinones improve the performance of flow cell batteries, but can be unsafe, unstable or expensive. Batteries with quinones, moreover, have shorter life times because of degradation, diffusion, crystallization and sublimation.

Low molecular weight (“small”) quinones (with molecular weight less than approximately 500) have been shown to improve the short-term performance and safety of batteries (Yao et al., 2010; Pirnat et al., 2012; Hanyu et al., 2013; Nawar et al. 2013). Yet, in batteries, small quinones are prone to degradation, diffusion across separators, crystallization and sublimation.

Large molecular weight quinones (with molecular weights that range in the thousands to the tens of thousands) solve some of the problems of small quinones (Zhao et al., 2013). Yet, large synthetic quinones are expensive, difficult to produce with well-defined chemical structures and prone to hydrolysis and degradation, for example by reduction of —OH groups or decarboxylation.

Eumelanin extracted from animal materials has been proposed as component in batteries [McGuinness, 1983; Kim et al., 2013]. Eumelanin is a large naturally occurring polymer derived in living cells from L-3,4-dihydroxyphenylalanine (hence the name DOPA-melanin). It is common in human skin, hair, sepia ink and fungi. It can also be extracted from plants such as black tea. While it has been previously shown that eumelanin can be charged and discharged with electrons while in batteries [McGuinness, 1983; Kim et al., 2013], the development of such batteries never extended from experimental models to commercial applications for a number of reasons:

(1) Eumelanin is costly to produce and presently sold by chemical companies for up to $300/gram depending on source and purity.

(2) Eumelanin is a heterogeneous chemical with unpredictable and poorly defined chemical structure, and is highly insoluble with a very broad molecular weight range (commonly between hundreds of thousands and one million).

(3) Because eumelanin is imprecise in dimension and structure it is also expected to have a broad range of redox potentials.

(4) Based on chemical structure, the density of electron exchanging groups in eumelanin are fewer than in small quinones and polyquinones, resulting in lower specific battery capacity (expressed in Ah/kg).

(5) In previous batteries, eumelanin has been used “as is.” Eumelanin has not been used in lithium-ion batteries because competition between proton and lithium ions in non-chemically altered melanin lowers the electrical capacity of batteries and increases the risk for lithium to bind electrons directly and to form lithium metal (Li^{o}).

The low conductivity and solubility of eumelanin and its tendency to clump in non-alkaline solutions, are likely responsible for slow rates of charge and discharge.

These features limit the potential of eumelanin as a component in batteries. Furthermore, no natural process, natural reservoir or method exists for high throughput and low cost production of eumelanin, toward small average molecular weight, size uniformity, predictable structure, high quinone density and narrow and steady electron exchange properties.

Citation or identification of any reference in Section 2, or in any other section of this application, shall not be considered an admission that such reference is available as prior art to the present invention.

### 3. SUMMARY

A method is provided for producing lithiated pyomelanin (LPM) comprising:

dissolving melanin in an alkaline lithium solution or in a solution comprising a mixture comprising:

LiOH; or

NaOH/KOH and a Li salt,

thereby producing an alkaline solution of lithium ions (Li⁺) comprising the melanin;

reducing the alkaline lithium solution comprising the melanin using a reducing agent or using a cathode of an electrochemical cell at an electrical potential ≤0.8V;

in a reducing environment and/or in an electrical potential ≤0.8V and under anaerobic conditions, titrating the alkaline lithium solution comprising the melanin to neutral pH;

in the reducing environment and/or in the electrical potential ≤0.8V and under anaerobic conditions, dialyzing the mixture relative to dH₂O (e.g., using a low cutoff dialysis membrane or filter), thereby producing a solution comprising LPM;

under anaerobic conditions, freezing the solution comprising LPM; and

lyophilizing the solution comprising LPM to remove water; thereby producing LPM.

In an embodiment, the dialysis is conducted at low temperature. In an embodiment, the low temperature (or cold conditions) is 1-5° C.

A method is provided for producing sodiated pyomelanin (SPM) comprising: dissolving melanin in an alkaline sodium solution or in a solution comprising a mixture comprising:

NaOH; or

KOH and a sodium salt,

thereby producing an alkaline solution of sodium ions (Na+) comprising the melanin;

reducing the alkaline sodium solution comprising the melanin using a reducing agent or using a cathode of an electrochemical cell at an electrical potential ≤0.8V;

in a reducing environment and/or in an electrical potential ≤0.8V and under anaerobic conditions, titrating the alkaline sodium solution comprising the melanin to neutral pH;

in the reducing environment and/or in the electrical potential ≤0.8V and under anaerobic conditions, dialyzing the mixture relative to dH₂O (e.g., using a low cutoff dialysis membrane or filter), thereby producing a solution comprising SPM;

under anaerobic conditions, freezing the solution comprising SPM; and

lyophilizing the solution comprising SPM to remove water; thereby producing SPM.

In an embodiment, the dialysis is conducted at low temperature. In an embodiment, the low temperature (or cold conditions) is 1-5° C.

A method for producing potassiated pyomelanin (PPM) comprising:

dissolving melanin in an alkaline potassium solution or in a solution comprising a mixture comprising:

KOH; or

NaOH and a potassium salt,

thereby producing an alkaline solution of potassium ions (K+) comprising the melanin;

reducing the alkaline potassium solution comprising the melanin using a reducing agent or using a cathode of an electrochemical cell at an electrical potential ≤0.8V;

in a reducing environment and/or in an electrical potential ≤0.8V and under anaerobic conditions, titrating the alkaline potassium solution comprising the melanin to neutral pH;

in the reducing environment and/or in the electrical potential ≤0.8V and under anaerobic conditions, dialyzing the mixture relative to dH₂O (e.g., using a low cutoff dialysis membrane or filter), thereby producing a solution comprising PPM;

under anaerobic conditions, freezing the solution comprising PPM; and

lyophilizing the solution comprising PPM to remove water; thereby producing PPM.

In an embodiment, the dialysis is conducted at low temperature. In an embodiment, the low temperature (or cold conditions) is 1-5° C.

A method is provided for producing a battery with increased safety, wherein the battery comprises an anode(−) compartment and a cathode(+) compartment, the method comprising:

providing a battery anode mixture;

providing lithiated pyomelanin (LPM), sodiated pyomelanin (SPM) and/or potassiated pyomelanin (PPM);

providing a battery electrolyte, wherein the battery electrolyte is non-aqueous or a proton-releasing chemical; and

adding the LPM, SPM and/or PPM to the battery anode mixture, thereby producing a battery anode mixture comprising the LPM, SPM and/or PPM, wherein the battery anode mixture comprising the LPM, SPM and/or PPM is in sufficiently low abundance so that when the battery is short-circuited or demand on the battery for electricity is large, heat released during discharge of the battery is less than a specific heat capacity of the battery, thereby:

increasing safety of the battery by avoiding formation of metallic lithium (Li^{o}) in the battery,

lowering the risk of overheating of the battery and/or lowering the risk of explosion of the battery, and

producing a battery with increased safety.

In an embodiment, the battery anode mixture is a carbon anode mixture.

In an embodiment, the LPM, SPM and/or PPM is added to and/or coated on a conductive surface of the anode compartment.

Lithiated pyomelanin (LPM), sodiated pyomelanin (SPM) and potassiated pyomelanin (PPM) are also provided.

### 4. BRIEF DESCRIPTION OF THE DRAWINGS

Exemplary embodiments are described herein with reference to the accompanying drawings, in which similar reference characters denote similar elements throughout the several views. It is to be understood that in some instances, various aspects of selected embodiments of the invention may be shown exaggerated, enlarged, exploded, or incomplete to facilitate an understanding of the invention.

FIGS. 1A-1C. A. Chemical structure of a fragment of lithiated pyomelanin (LPM) in a fully charged state. B-C. The structures of sodiated pyomelanin (SPM) (FIG. 1B) and potassiated pyomelanin (PPM) (FIG. 1C) are identical with the structure of LPM except that Li is replaced by Na and K respectively.

FIGS. 2A-2B. Fragments of two pyomelanin molecules with 12 homogentisic acid (HGA) monomers each. Two basic configurations of pyomelanin chain exist (A and B). In this diagram, the A configuration is the upper structure and the B configuration is the lower structure. Dashed ovals indicate a HGA monomer. Each molecule of pyomelanin from bacteria may have ˜60-80 HGA units, a molecular weight between 12,000 and 14,000 and will be approximately 21 nm long.

FIGS. 3A-3B. Diagram of the organization and functioning of a rechargeable lithium ion lithiated pyomelanin (LPM):metal hybrid battery.

FIG. 4. Chemical structures of two types of eumelanin, pheomelanin, α-pyomelanin, and β-pyomelanin.

FIG. 5. Graph of results showing the specific capacity of a battery system with LPM in the anode(−) and lithium ion as the mobile phase. The X-axis is cycle number. The Y-axis is specific capacity (mAh/g). The cycling has occurred at very slow rate (˜C/200).

FIGS. 6A-6B. Graphs of results showing the performance of a coin cell LPM lithium ion battery during a fifth cycle at 5 mA/g constant current (Panel A) (FIG. 6A) and 100 mA/g constant current (Panel B) (FIG. 6B). The X-axes are melanin specific capacity (mAh/g). The Y-axes are voltage (V).

FIG. 7. A cyclic voltammogram showing the electrochemical properties of pyomelanin produced by the method of U.S. Pat. No. 8,815,539 B1 to Popa and Nealson. It shows that pyomelanin can be charged and discharged with electrons while in batteries. The OX axis represents voltage (measured in Volts). The OY axis represents electrical current (measured in Amps).

FIGS. 8A-8B. (A) First cycle voltage profiles for a 80 (melanin):10 (PVDF):10 (SuperC5) anode composite versus Lithium/L⁺ (at 5 mA/g constant current. (B) Short term cycling and coulombic efficiencies at a C/2 rate.

FIGS. 9A-9B. (A) Voltage lithium extraction profiles for melanin anode versus Lithium/L⁺ at C/5, C/2, 1C, 2C, and 5C. (B) Capacity as a function of discharge rate for melanin anode versus Lithium/Li+.

FIGS. 10A-10B. (A) First cycle voltage profile for LiOH treated melanin anode composite versus Lithium/Li⁺ at a 5 mAh/g rate. (B) Short term cycling and coulombic efficiencies at a C/5 rate.

FIGS. 11A-11B. (A) First cycle voltage profile for MCMB control and melanin added to MCMB anode composites versus Lithium/L⁺ at a 30 mAh/g rate. (B) Capacity as a function of discharge rate for MCMB control and melanin additive MCMB anodes versus Lithium/L⁺.

FIGS. 12A-12B. (A) First cycle voltage profile for NCA cathode versus melanin anode at a C/10 rate. (B) Short term cycling and coulombic efficiencies at a C/10 rate.

### 5. DETAILED DESCRIPTION OF THE INVENTION

Methods are provided for producing lithiated pyomelanin (LPM), sodiated pyomelanin (SPM), and potassiated pyomelanin (PPM). These inexpensive polyquinones can be used in batteries that are charged and discharged multiple times, with predictable redox potential and chemically stability. The use of LPM, SPM and/or PPM in such batteries can mitigate safety problems that could arise in the batteries.

Lithiated pyomelanin (LPM), sodiated pyomelanin (SPM) and potassiated pyomelanin (PPM) are also provided.

A method for producing a battery that has increased safety is also provided. In embodiments, the battery with increased safety is a Li-ion battery, a Na-ion battery, or a K-ion battery, or a combination Li-, Na- and/or K-ion battery.

For clarity of disclosure, and not by way of limitation, the detailed description of the invention is divided into the subsections set forth below.

5.1. Pyomelanin

Pyomelanin is a polymer of 1,4-benzoquinoacetic acid, produced by living cells via oxidation of homogentisic acid. Pyomelanin is common in nature, frequent in bacteria and present in some fungi (Schmaler-Ripcke et al., 2009). It is also present in animals where it is called alkaptomelanin. Pyomelanin can also be prepared by chemical synthesis via the oxidation of homogentisic acid. Based on properties of the carboxyl group pyomelanin can also be bound to various substrates or derivatized into other chemicals.

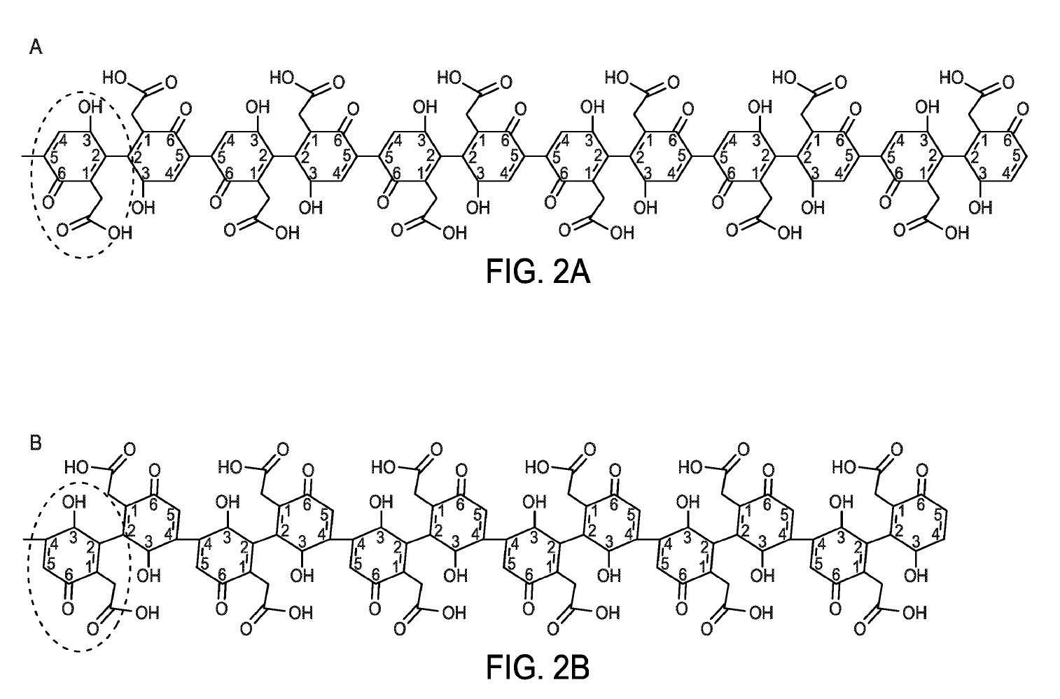

Pyomelanin is present in two principal molecular configurations called A and B (FIGS. 2A-2B), in various combinations (Turick et al., 2010).

Because each monomer of homogentisate (HGA, FIG. 2A or B) from pyomelanin can exist in three redox states (quinone, semiquinone and hydroquinone), pyomelanin can be charged and discharged with electrons multiple times, similar to other quinones and polyquinones (Sarna and Swartz, 2006; Roginsky et al., 1999; Turick et al., 2010). Because each monomer of pyomelanin can exchange up to two electrons, the upper threshold of the specific capacity of pyomelanin in a battery is approximately 320 Ah kg⁻¹ (or 1.15·10⁶ Coulombs kg⁻¹).

Pyomelanin can be produced at low cost using the methods of U.S. Pat. No. 8,815,539 B1 to Popa and Nealson (2014). According to these methods, food waste or carbohydrates are used as the major food stock for the bacteria, leading to a virtually inexhaustible supply of pyomelanin. Melanin produced by this method is highly enriched in pyomelanin and can be used in energy storage devices.

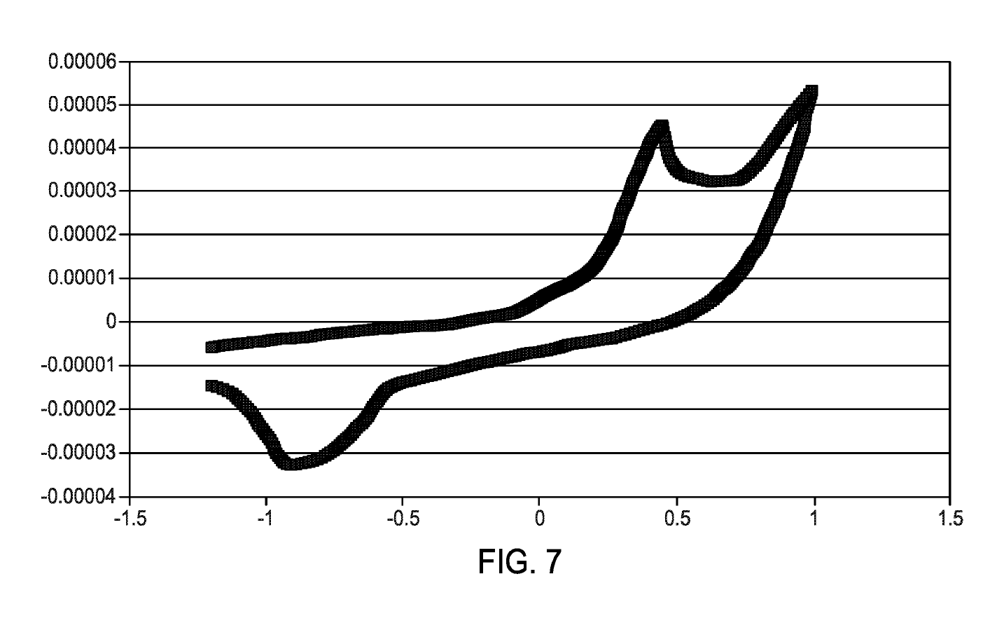

Pyomelanin has several advantages over eumelanin in constructing batteries. Pyomelanin has better battery properties than eumelanin, as discussed above, although it retains the same general weakness (i.e., proton-lithium competition). Furthermore, pyomelanin can be obtained from bacteria at much lower cost relative to eumelanin, using the method disclosed in U.S. Pat. No. 8,815,539 B1 to Popa and Nealson. FIG. 7 shows a cyclic voltammogram showing the electrochemical properties of pyomelanin produced by the method. It shows that the pyomelanin can be charged and discharged with electrons while in batteries. The OX axis represents voltage (measured in Volts). The OY axis represents electrical current (measured in Amps).

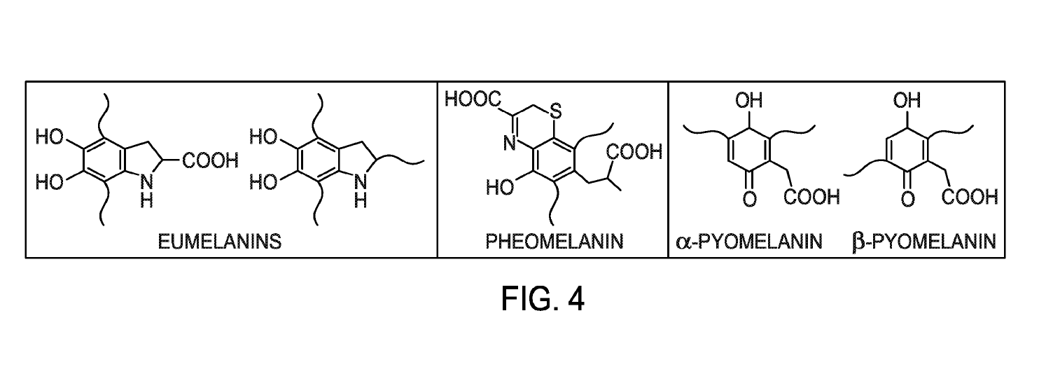

The structures of pyomelanin and eumelanin differ (FIG. 4). Pyomelanin also has a different biochemical origin than eumelanin; i.e., pyomelanin is a polymer of homogentisic acid while eumelanin is a polymer of L-3,4-dihydroxyphenylalanine (DOPA). Pyomelanin is smaller and has a considerably narrower range of molecular size (approximately 8,000-14,000 MW) than eumelanin (hundreds of thousands to one million MW).

Pyomelanin is more soluble in aqueous solutions than eumelanin, i.e., ≥40 mg/ml in 1 N NH₄OH for pyomelanin obtained according to the methods described in U.S. Pat. No. 8,815,539 B1 to Popa and Nealson versus 20 mg/ml in 1 N NH₄OH for synthetic eumelanin (from Sigma-Aldrich, product # M8631). Thus, pyomelanin is more amenable to flow cell batteries than eumelanin. This is because eumelanin is a very large molecule that will not create a good homogeneous solution. Also, owing to the size and stickiness of eumelanin, eumelanin clogs pores of ion exchange membranes.

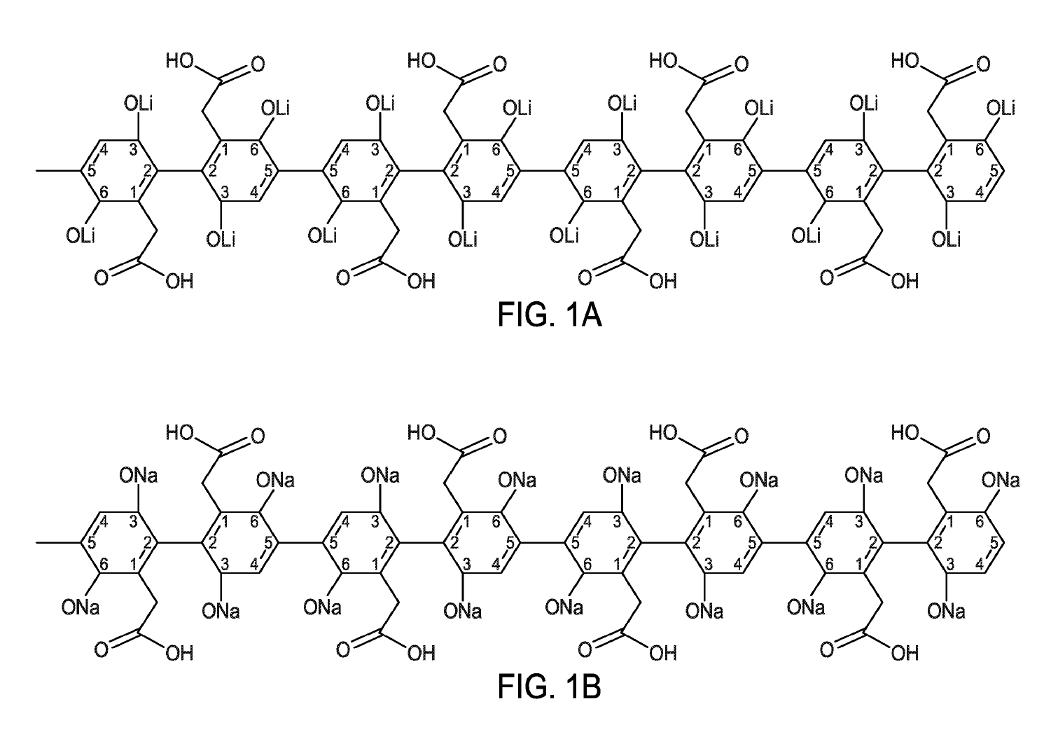

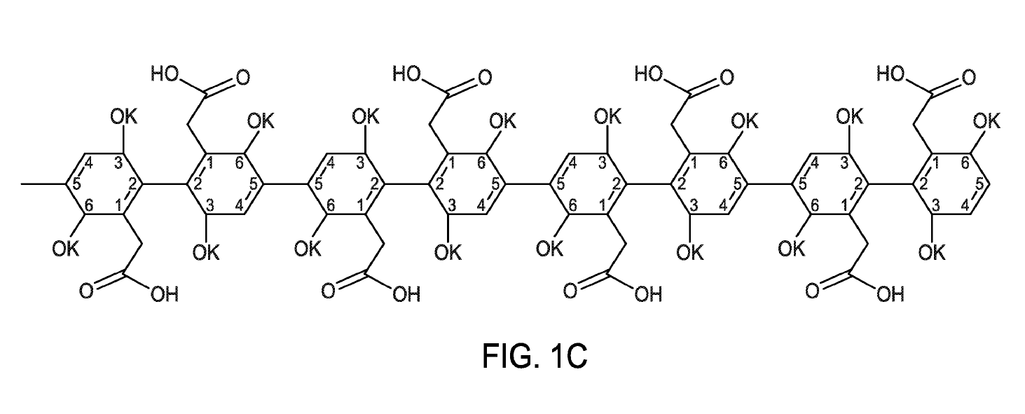

Pyomelanin is generally regarded as preferable to eumelanin for use in batteries, because pyomelanin has higher density of quinone groups, smaller molecular size and is more homogeneous in molecular size. Pyomelanin has very high density of electron exchange groups (approximately one quinone group and four exchangeable electrons for each 8 carbons; see FIG. 1) and thus its use in batteries will result in batteries with large specific capacity (upwards to 320 Ah/kg or 1.15·10⁶ Coulombs kg⁻¹).

When used in Li-ion, Na-ion or K-ion batteries, pyomelanin will confer advantages relative to small quinones (see, e.g., Pirnat et al., 2012; Zhao et al 2013; Zou et al., 2014), including increased stability, no diffusion across separators and no sublimation.

Pyomelanin, unlike eumelanin, has been naturally selected for multiple electron exchange reactions (i.e., repetitive oxidation and reduction) by bacterial cells (Turick et al., 2010). Because pyomelanin has higher density of redox active groups per mole, pyomelanin is better than eumelanin for use in batteries. Eumelanin has been used previously to produce sodium-ion batteries (for sodium-ion battery technology, see, e.g., Kim et al., 2013).

As defined herein, “pyomelanin” includes, but is not limited to bacterially synthesized or produced pyomelanin, chemically-produced pyomelanin, pyomelanin with various levels of purity, hydrolysates of pyomelanin, compounds similar in structure to bacterial pyomelanin, chemically derivatized pyomelanin (such as derivatization of the carboxylic group of pyomelanin to pyomelanin-methyl ester; pyomelanin ethyl ester pyomelanin isopropyl ester; pyomelanin n-propanol ester; pyomelanin n-butyl ester; pyomelanin isobutyl ester; pyomelanin isoamyl ester; pyomelanin n-amyl ester; pyomelanin silylated with bis (trimethylsilyl) trifluoroacetamide; pyomelanin derivatized with dimethylformamide; pyomelanin butoxyethyl ester; pyomelanin butoxyethyl ester; pyomelanin butyl dimethyl silyl ester; pyomelanin anilide; pyomelanin derivatives prepared by methods known in the art, such as those disclosed in Knapp, 1979, and chemical complexes rich in pyomelanin or derived from pyomelanin (such as pyomelanin protein complexes).

5.2. Method for Producing Lithiated Pyomelanin (LPM), Sodiated Pyomelanin (SPM) and Potassiated Pyomelanin (PPM)

Pyomelanin is a polyquinone that can be obtained from bacteria (Turick et al., 2002; 2008), enriched from bacteria with the help of black soldier fly larvae (U.S. Pat. No. 8,815,539 B1 to Popa and Nealson) or produced by chemical synthesis (Turick et al., 2010).

Pyomelanin can be chemically transformed into LPM or combined with another alkaline metallic cation such as (Na⁺, K⁺, Cu⁺, Rb, Ag, or Cs) and then used in batteries.

We have developed a method for producing LPM, SPM or PPM for use in Li-ion, Na-ion or K-ion batteries, respectively.

FIGS. 1A-C show the basic structures of LPM (FIG. 1A), SPM (FIG. 1B) and PPM (FIG. 1C). The structures of SPM (FIG. 1B) and PPM (FIG. 1C) are identical with the structure of LPM (FIG. 1A) except that Li is replaced by Na and K respectively.

In an embodiment, the method for producing LPM comprises dissolving melanin in an alkaline lithium solution (for example 1 M LiOH, pH 14). Solutions comprising mixtures of NaOH/KOH and Li salts can also be used for dissolving the melanin. The alkaline solution comprising the melanin is reduced using a reducing agent or using a cathode of an electrochemical cell at an electrical potential ≤0.8V.

In one embodiment, the reducing agent is dithiothreitol, dithionite or sulfide.

In a specific embodiment in which the melanin comprised in the alkaline solution is pyomelanin, reducing agents that can be used include, but are not limited to, hydrogen sulfide (H₂S) and lithium sulfide (Li₂S). Lithium sulfide has the advantage of simultaneously producing an alkaline solution, releasing lithium ions, releasing sulfide and removing oxygen. If sulfide chemicals are used, the LPM gel can be washed free of colloidal sulfur (S^{o}) with chemicals that dissolve S^{o} such as carbon disulfide, toluene, ethanol, benzene or ether.

In an embodiment, the cathode is a platinum wire cathode.

In an embodiment, while in a reducing environment and/or in an electrical potential ≤0.8V and under anaerobic conditions, the mixture is titrated to neutral pH. In the same reducing conditions, the mixture is then dialyzed in a cold room (e.g., cold conditions of 1-5° C. are commonly used in the art) relative to dH₂O. The dialysis can be conducted using a dialysis membrane or filter with low cutoff of 12 kDa or smaller. In an embodiment, a dialysis membrane with a cutoff of 3.5 kDa is used. After dialysis, the solution comprising LPM is frozen in anaerobic conditions and lyophilized to remove water. This produces highly reduced LPM and exchangeable protons from quinone groups replaced by lithium.

In an embodiment, the method for producing LPM comprises:

dissolving melanin in an alkaline lithium solution or in a solution comprising a mixture comprising:

LiOH; or

NaOH/KOH and a Li salt,

thereby producing an alkaline solution of lithium ions (Li⁺) comprising the melanin;

reducing the alkaline lithium solution comprising the melanin using a reducing agent or using a cathode of an electrochemical cell at an electrical potential ≤0.8V;

in a reducing environment and/or in an electrical potential ≤0.8V and under anaerobic conditions, titrating the alkaline lithium solution comprising the melanin to neutral pH;

in the reducing environment and/or in the electrical potential ≤0.8V and under anaerobic conditions, dialyzing the mixture relative to dH₂O (e.g., using a low cutoff dialysis membrane or filter), thereby producing a solution comprising LPM;

under anaerobic conditions, freezing the solution comprising LPM; and

lyophilizing the solution comprising LPM to remove water; thereby producing LPM.

In an embodiment, the dialysis is conducted at low temperature or in cold conditions (such as a cold room). In an embodiment, the low temperature (or cold conditions) is 1-5° C.

In other embodiments, sodiated pyomelanin (SPM) or potassiated pyomelanin (PPM) are produced instead of LPM.

In an embodiment, the method for producing sodiated pyomelanin (SPM) comprises:

dissolving melanin in an alkaline sodium solution or in a solution comprising a mixture comprising:

NaOH; or

KOH and a sodium salt,

thereby producing an alkaline solution of sodium ions (Na+) comprising the melanin;

reducing the alkaline sodium solution comprising the melanin using a reducing agent or using a cathode of an electrochemical cell at an electrical potential ≤0.8V;

in a reducing environment and/or in an electrical potential ≤0.8V and under anaerobic conditions, titrating the alkaline sodium solution comprising the melanin to neutral pH;

in the reducing environment and/or in the electrical potential ≤0.8V and under anaerobic conditions, dialyzing the mixture relative to dH₂O (e.g., using a low cutoff dialysis membrane or filter), thereby producing a solution comprising SPM;

under anaerobic conditions, freezing the solution comprising SPM; and

lyophilizing the solution comprising SPM to remove water; thereby producing SPM.

In an embodiment, the dialysis is conducted at low temperature or in cold conditions (such as a cold room). In an embodiment, the low temperature (or cold conditions) is 1-5° C.

In an embodiment, the method for producing potassiated pyomelanin (PPM) comprises:

dissolving melanin in an alkaline potassium solution or in a solution comprising a mixture comprising:

KOH; or

NaOH and a potassium salt, thereby producing an alkaline solution of potassium ions (K+) comprising the melanin;

reducing the alkaline potassium solution comprising the melanin using a reducing agent or using a cathode of an electrochemical cell at an electrical potential ≤0.8V;

in a reducing environment and/or in an electrical potential ≤0.8V and under anaerobic conditions, titrating the alkaline potassium solution comprising the melanin to neutral pH;

in the reducing environment and/or in the electrical potential ≤0.8V and under anaerobic conditions, dialyzing the mixture relative to dH₂O (e.g., using a low cutoff dialysis membrane or filter), thereby producing a solution comprising PPM;

under anaerobic conditions, freezing the solution comprising PPM; and

lyophilizing the solution comprising PPM to remove water; thereby producing PPM.

In an embodiment, the dialysis is conducted at low temperature or in cold conditions (such as a cold room). In an embodiment, the low temperature (or cold conditions) is 1-5° C.

Lithiated pyomelanin (LPM), sodiated pyomelanin (SPM) and potassiated pyomelanin (PPM) are also provided. In embodiments, the LPM, SPM or PPM are produced using the methods disclosed herein.

In one embodiment, the pyomelanin from which LPM is produced is made by the method disclosed in U.S. Pat. No. 8,815,539 B1 to Popa and Nealson (2014). Melanin produced by this method is highly enriched in pyomelanin and can be used in energy storage devices. The pyomelanin is then separated into fractions based on solubility and molecular size using methods well known in the art, such as precipitation at various pHs, centrifugation, filtration, gel chromatography, or dialysis.

The pyomelanin is chemically altered by lithiation (or sodiation or potassiation). In one embodiment, the pyomelanin is lithiated (or sodiated or potassiated) after separation into fractions, because separation into fractions involves solutions at pH values less than strongly alkaline. In such conditions, lithium/hydrogen (or sodium/hydrogen or potassium/hydrogen) swap in water, and this can lower the efficiency of lithiation (or sodiation or potassiation). In another embodiment, the pyomelanin is lithiated (or sodiated or potassiated) before separation into fractions.

In a specific embodiment of pyomelanin lithiation, pyomelanin is treated with lithium ions in alkaline pH, and then filtered, washed and dried to remove small quinones, hydroxide ions, alkali, free lithium, salts and water. Likewise, pyomelanin can also be sodiated or potassiated by this treatment.

Titration can be performed using titrating agents known in the art. In one embodiment, a solution of 1 M of HCl is used as titrating agent.

Dialysis can be performed using methods known in the art. In one embodiment, dialysis is performed using a membrane with cutoff that is smaller or equal to 8,000 MW, such as a quantitative cellulose filter (e.g., from Whatman plc, Maidstone, UK). In an embodiment, dialysis is performed at a cold temperature of between about 0.5 and about 10° C.

Freezing prior to lyophilization can be done, for example, between −40° C. and −80° C. in a convention freezer or at −78° C. (by using carbonic (“dry”) ice). In a specific embodiment, dialysis is performed in a cold room at a temperature of between about 0.5° C. and about 5° C.

In a specific embodiment of the method for producing LPM, solutions saturated with melanin are produced by adding up to 50 g pyomelanin per liter in solutions of 1.0-2.5M NaOH/KOH (pH 14-14.4 respectively) and then brought to a temperature of 99° C. in a boiling water bath. To produce a complex with lithium, LiOH, or a mixture of NaOH/KOH and a lithium salt, can be added. Lithium salts (as well as sodium salts and potassium salts) are well known in the art.

After 1-2 hours of heating, the mixture is left to cool off at room temperature. Upon cooling, the mixture becomes a gel and the undissolved melanin is removed by centrifugation (4,500 rpm for 30 min at 20° C.). This method for producing LPM can be altered by the skilled practitioner according to the methods disclosed herein to produce a complex with sodium or potassium for production of SPM or PPM, respectively.

The pyomelanin solubility achieved is between 20-50 g/L depending upon pH, temperature, centrifugation conditions and the molecular size of melanin. The pyomelanin is assumed to have a molecular mass between 8,000 and 14,000. Thus under conditions of pH 14 and 99° C., the above-described method will produce a solution with approximately 40 g/L of LPM.

LPM (or SPM or PPM) is added to a battery anode mixture in specific proportions depending on battery performance targets. These proportions can be calculated using routine methods.

In an embodiment, the method for increasing the safety of a Li-ion battery comprises applying LPM in layers coating some or all conductive surfaces in the anode compartment. This minimizes the formation of lithium metal (or sodium metal or potassium metal) while the battery is charged.

In another embodiment, the method for increasing the safety of a Na-ion battery comprises applying SPM in layers coating some or all conductive surfaces in the anode compartment. This minimizes the formation of sodium metal while the battery is charged.

In yet another embodiment, the method for increasing the safety of a K-ion battery comprises applying PPM in layers coating some or all conductive surfaces in the anode compartment. This minimizes the formation of potassium metal while the battery is charged.

Lithiation, sodiation or potassiation of pyomelanin lowers the risk of overheating and explosion of Li-ion, Na-ion, or K-ion batteries, respectively.

Electro/chemical reduction, alkaline conditions, and increase in concentration of reagents by dehydration can be used to bind pyomelanin with alkaline metallic cations such as L⁺, Na⁺, K⁺, Cu⁺, Rb⁺, Ag⁺, and Cs⁺. For example, during chemical reduction, pyomelanin stores lithium ions (Li⁺), sodium ions (Na⁺) or potassium ions (K⁺) along with electrons in Li-ion, Na-ion or K-ion batteries, respectively.

LPM placed in the anode mixtures of Li-ion batteries will help avoid formation of metallic lithium (Li^{o}). LPM coating anode conductive surfaces in Li-ion batteries will also help avoid formation of metallic lithium. Similarly, SPM or PPM can be used in the anode mixtures or coating anode conductive surfaces to avoid the formation of metallic sodium or metallic potassium.

During the discharge of LPM Li-ion batteries that also contain lithium adsorbed to carbon (LixC₆), after the reservoir of free lithium (xLiC₆) from the anode has been exhausted, the Maximum Discharge Current is controlled by the rate of LPM oxidation. It is well known in the art that batteries have Maximum Discharge Current specifications. If they are discharged too fast they overheat and are damaged. Thus in the LPM-lithium ion battery disclosed herein, after the initial fast release of electrons from carbon, the remaining electrons are released slowly because they are bound to melanin. Because this reaction is slower than the release of electrons from carbon, the battery does not overheat even if the external resistance is very low or electricity demand is very large.

To produce safe batteries, the amount of free lithium (xLiC₆ and Li^{o}) in a fully charged battery anode (−), should be less than the amount needed to increase the temperature of the battery past the safe point temperature. These values are established based on the heat released by the reaction shown below and the specific heat capacity of the battery:

Li⁺+=Li^{o}(s)

Similar calculations to the above can be made for the amount of free sodium or free potassium.

LPM (or SPM or PPM) can be charged/discharged multiple times with no change in the basic structure of the quinone ring.

The safety of Li-ion (or Na-ion or K-ion) batteries containing LPM (or SPM or PPM) is directly proportional to the level of sequestration of lithium (or sodium or potassium) by pyomelanin and inversely proportional to the conductive surfaces from the anode that is not coated with pyomelanin.

LPM, SPM or PPM can be employed in the production of various battery configurations (stationary, flow cells, sandwich); and various standard and non-standard forms (including but not limited to coin cells, buttons, cylindrical and pouch cells).

LPM improves the properties of Li-ion batteries, in including increased safety, lower rate of discharge when external resistance is low; capacity, recharging, cost, and earth-safe recycling. Similarly, SPM or PPM can be used to improve such properties in Na-ion or K-ion batteries.

LPM, SPM or PPM can be used in Li-ion, Na-ion or K-ion batteries, respectively, as a controller of runaway reactions and will increase the safety of batteries with regard to overheating, melting, deformation or explosion.

In Li-batteries, LPM will partly replace other electron-storing chemicals from the anode compartment. Such chemicals include but are not limited to mesocarbon microbeads, carbon, acetylene black, graphite and titanium oxide. Similarly, SPM or PPM can be used in such replacements in Na-ion or K-ion batteries.

Because it is soluble at alkaline pH and can be fragmented into shorter quinone oligomers, pyomelanin can also be used in flow-cell batteries.

Because pyomelanin is made from an abundant waste material (food waste, wheat bran, and molasses), and because pyomelanin only contains C, H and O, there is no limit to the supply.

No foreseeable limits exist on the amount of melanin that can be recycled in nature because the source components used by living cells to produce polyphenols de novo (namely CO₂ and H₂O) are 100% recycled at the earth's surface.

LPM, SPM or PPM are easy to recycle because they release lithium, sodium, or potassium, respectively, during oxidation reactions.

5.3. Methods for Producing Li-Ion, Na-Ion or K-Ion Batteries with Increased Safety and for Improving Safety of Batteries

A method is provided for improving the safety of Li-ion batteries by reducing the likelihood that they will overheat and/or explode. The method comprises using a chemically altered mixture containing LPM in the negative compartment (anode) of the Li-ion battery.

A method is also provided for producing Li-ion batteries with increased safety and less likelihood of exploding. The method comprises using a chemically altered mixture containing LPM in the negative compartment (anode) of the Li-ion battery.

Lithium is released from LPM in a slow reversible reaction. Using LPM, the Maximum Discharge Current becomes limited when external conductivity is very large, the occurrence of free lithium discharge is lower and so is the risk of explosion because the oxidation of Lithiated-melanin with water is a slow process.

Similarly, in other embodiments, sodiated pyomelanin (SPM) or potassiated pyomelanin (PPM) can be used instead of LPM to improve the safety of Na-ion or K-ion batteries, respectively.

Methods for producing a lithium-ion (Li-ion), sodium-ion (Na-ion) or potassium-ion (K-ion) battery that has increased safety are also provided. To produce a battery with increased safety, the following guidelines can be followed:
Exchangeable protons from quinone groups of melanin are substituted by lithium or by another similar metal (such as sodium or potassium).
For lithium (or sodium or potassium) to over-compete protons, the amount of mobile lithium (or sodium or potassium) in a battery is in excess of the lithium (or sodium or potassium) that can be stored by the quinone groups of melanin.
To avoid water electrolysis, the electrolyte is non-aqueous or any other proton-releasing chemical.
The battery is assembled in a moisture free environment.
The carbon from the anode(−) mixture is in sufficiently low abundance so that when the battery is short-circuited or the demand of electricity is large, the heat released during discharge is less than the specific heat capacity of the battery.

In an embodiment, a method is provided for producing a battery with increased safety, wherein the battery comprises an anode(−) compartment and a cathode(+) compartment, the method comprising:

providing a battery anode mixture;

providing lithiated pyomelanin (LPM), sodiated pyomelanin (SPM) and/or potassiated pyomelanin (PPM);

providing a battery electrolyte, wherein the battery electrolyte is non-aqueous or a proton-releasing chemical; and

adding the LPM, SPM and/or PPM to the battery anode mixture, thereby producing a battery anode mixture comprising the LPM, SPM and/or PPM, wherein the battery anode mixture comprising the LPM, SPM and/or PPM is in sufficiently low abundance so that when the battery is short-circuited or demand on the battery for electricity is large, heat released during discharge of the battery is less than a specific heat capacity of the battery, thereby:

increasing safety of the battery by avoiding formation of metallic lithium (Li^{o}), sodium (Na^{o}) and/or potassium (K^{o}) in the battery,

lowering risk of overheating of the battery and/or lowering risk of explosion of the battery, and

producing a battery with increased safety.

Battery anode mixtures are well known in the art. In an embodiment, the battery anode mixture is a carbon anode mixture.

Battery electrolytes that are non-aqueous or that are (or comprise) proton-releasing chemicals are well known in the art.

In an embodiment, the LPM, SPM and/or PPM is added to and/or coated on a conductive surface of the anode compartment.

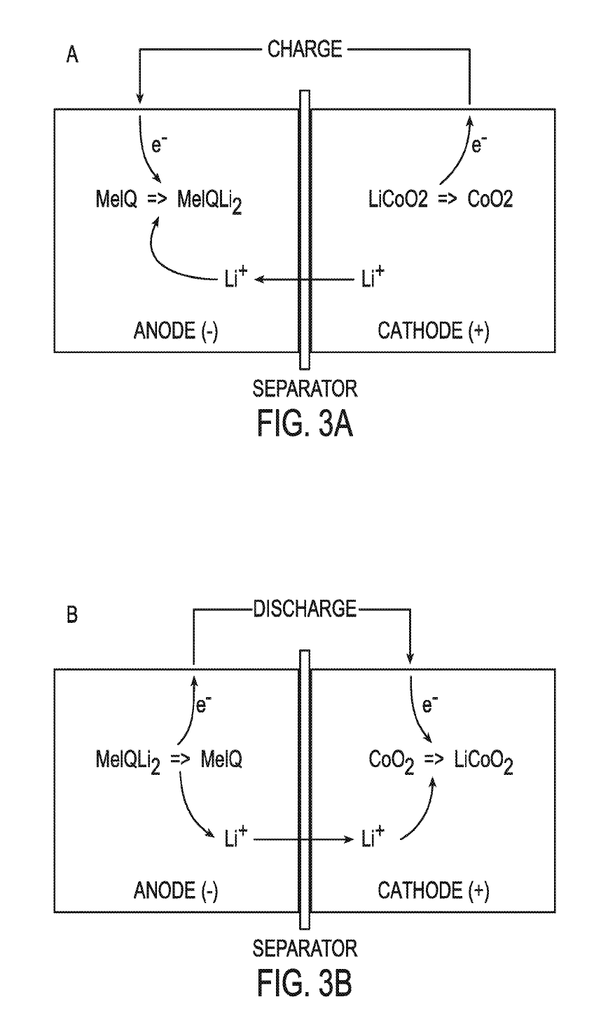

FIGS. 3A-3B show diagrams of the organization and functioning of one embodiment of a rechargeable lithium ion lithiated pyomelanin (LPM):metal hybrid battery. The anode(−) compartment of the battery comprised 80 wt % lithiated pyomelanin (LPM), 10 wt % Super C65 carbon black and 10 wt % polyvinylidene fluoride (PVDF). The LiNiCoAlO₂ cathode(+) compartment comprised 92 wt % LiNi_{0.8}Co_{0.152}Al_{0.05}O₂ (NCA), 4 wt % KYNAR Powerflex polyvinylidene fluoride (PVDF), and 4 wt % Super C65 in N-Methyl-2-pyrrolidone (NMP). The electrolyte was 1.2M LiPF₆ in ethylene carbonate (EC) and ethyl methyl carbonate (EMC) at a ratio of 3:7 by volume, respectively. The separator was Celgard membrane (Celgard, LLC, 13800 South Lakes Dr., Charlotte, N.C., USA 28273.

The LPM Anode versus NCA cathode battery can be assembled into any suitable battery form type known in the art. In one study, it was assembled in a CR2032 form type. Average voltage was 1.5 V with sloping profile. It was tested at C/40, C/5, C/2, 1C, 2C, and 5C and showed significant capacity reduction above C/2. First cycle Coulombic efficiency of melanin anode versus lithium was ˜40%, and improved after a few cycles. After 5 cycles at very slow discharge rate (5 mA/g constant current) the battery showed major improvement in capacity (380 mAh/g, which is very close to the maximum theoretical capacity of melanin to store redox electrons) and high Coulombian efficiency (˜85%).

In another embodiment, the battery is a rechargeable lithium ion metal/LPM hybrid battery. The battery comprises Nickel-Cobalt-Aluminum oxide (or another mixture of chemicals accepting electrons upon battery discharge) in the cathode(+) compartment and a mixture of LPM and carbon (used to store electrons when the battery is charged) in the anode(−) compartment. A non-aqueous electrolyte is used, such as 1.2M LiPF₆ in ethylene carbonate (EC) and ethyl methyl carbonate (EMC) at a ratio of 3:7 by volume, respectively. Non-aqueous electrolyte allows charging and discharging the battery without producing water electrolysis that increases the risk of damaging the battery upon usage. The two battery compartment (anode(−) and cathode(+)) are separated by a membrane that is permeable to lithium but has little permeability to electrons (such as a Celgard membrane).

In other embodiments, SPM or PPM is used instead to produce a rechargeable sodium ion metal/SPM hybrid battery or potassium ion metal/PPM hybrid batter.

### REFERENCES

1. Gaberscek M., 2012. Electrochemically stabilized quinone-based electrode composites for Li-ion batteries. J. Power Sources, 199:308-314.
2. Hanyu Y., Y. Ganbe and I. Houma, 2013, Application of quinonic cathode compounds for quasi-solid lithium batteries, J. Power Sources, 223:188-190.
3. Kim Y. J., W. Wu, S. E. Chun, J. F. Whitacre and C. J. Bettinger, 2013, Biologically derived melanin electrodes in aqueous sodium-ion energy storage devices, PNAS, 110(52):20912-20917.
4. Knapp D. R., 1979, Handbook of analytical derivatization reactions, Wiley.
5. McGuinness, 1983. U.S. Pat. No. 4,504,557.
6. Pirnat K., R. Dominko, R. Cerc-Korosec, G. Mali, B. Genorio and M. Gaberscek, 2012, Electrochemically stabilised quinone based electrode composites for Li-ion batteries, Journal of Power Sources, 199:308-314.
7. Popa, R. and Nealson, K. 2014. U.S. Pat. No. 8,815,539 B1.
8. Nawar S., B. Huskinson and M. Aziz, 2013, Benzoquinone-hydroquinone couple for flow battery, Mater. Res. Soc. Symp. Proc., 1491-1496.
9. Roginsky V. A., L. M. Pisarenko, W. Bors and C. Michel, 1999, The kinetics and thermodynamics of quinone-semiquinone-hydroquinone systems under physiological conditions, J. Chem. Soc., Perkin Trans., 2:871-876.
10. Sarna T. and H. A. Swartz, 2006, The physical properties of melanin, in The pigmentary system: physiology and pathophysiology, J. J. Nordlund (ed.), Chapt. 16, 311-341.
11. Schmaler-Ripcke J., V. Sugareva, P. Gebhardt, R. Winkler, O. Kniemeyer, T. Heinekamp and A. A. Brakhage, 2008, Production of pyomelanin, a second type of melanin, via the tyrosine degradation pathway in Aspergillus fumigatus, Appl. Environ. Microbiol. 2009, 75:493-503.
12. Turick C. E., A. S. Knox, J. M. Becnel, A. A. Ekechukwu and C. E. Milliken, 2010, Properties and function of pyomelanin, in M. Elnashar (ed.), Biopolymers, Chapt. 23, 449-472.
13. US Patent Application No: 2003/0118,877, Armand M., C. Michot and N. Ravet, New electrode materials derived from polyquinonic ionic compounds and their use in electrochemical generators.
14. Yao M., H. Senoh, S. Yamazaki, Z. Siroma, T. Sakai and K. Yasuda, 2010, High-capacity organic positive-electrode material based on a benzoquinone derivative for use in rechargeable lithium batteries, J. Power Sources, 195:8336-8340.
15. Zhao L., W. Wang, A. Wang, K. Yuan, S. Chen and Y. Yang, 2013, A novel polyquinone cathode material for rechargeable lithium batteries, J. Power Sources, 233:23-27.
16. Zou Q., W. Wang, A. Wang, Z. Yu and K. Yuan, 2014, Preparation of the tetrahydro-hexaquinone as a novel cathode material for rechargeable lithium batteries, Materials Letters, 117:290-293.

The following example(s) are offered by way of illustration and not by way of limitation.

### 6. EXAMPLES

### 6.1. Example 1: Rechargeable Lithium Ion Metal/LPM Hybrid Battery

This example describes an embodiment of a rechargeable lithium ion metal/LPM hybrid battery. This battery comprises Nickel-Cobalt-Aluminum oxide in the cathode(+) compartment (92 wt % LiNi_{0.8}Co_{0.152}Al_{0.05}O₂ (NCA), 4 wt % KYNAR Powerflex polyvinylidene fluoride (PVDF), and 4 wt % Super C65 in NMP), and a mixture of 80% LPM, 10% Super C65 carbon black and 10% PVDF ligand in the anode(−) compartment. The electrolyte comprised 1.2M LiPF6 in ethylene carbonate (EC) and ethyl methyl carbonate (EMC) at a ratio of 3:7 by volume, respectively. The two battery compartment (anode(−) and cathode(+)) are separated by a Celgard lithium permeable membrane (Celgard, LLC, 13800 South Lakes Dr., Charlotte, N.C., USA 28273). The battery was assembled in a coin cell form type C2032.

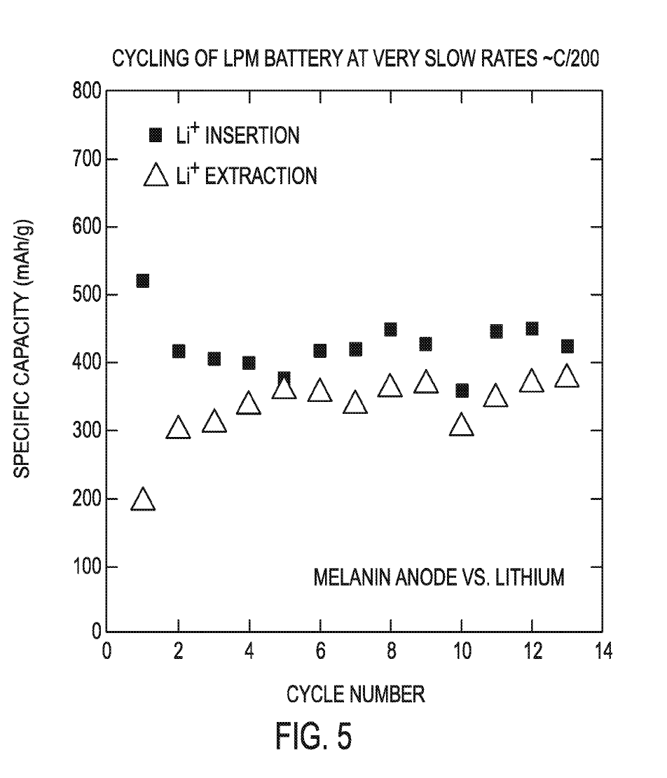

Results showing the charging and discharging of melanin anode versus lithium at ˜C/200 are shown in FIG. 5.

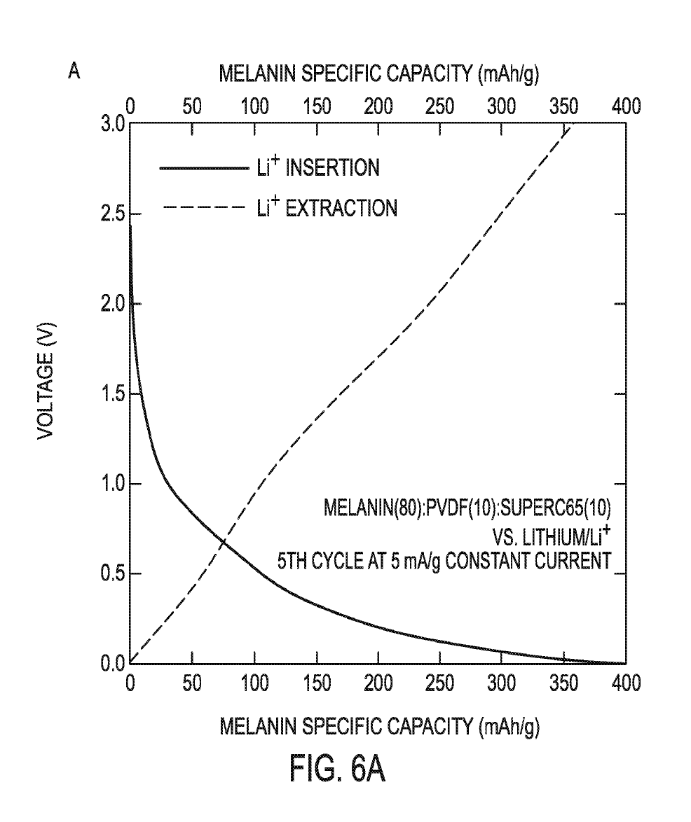

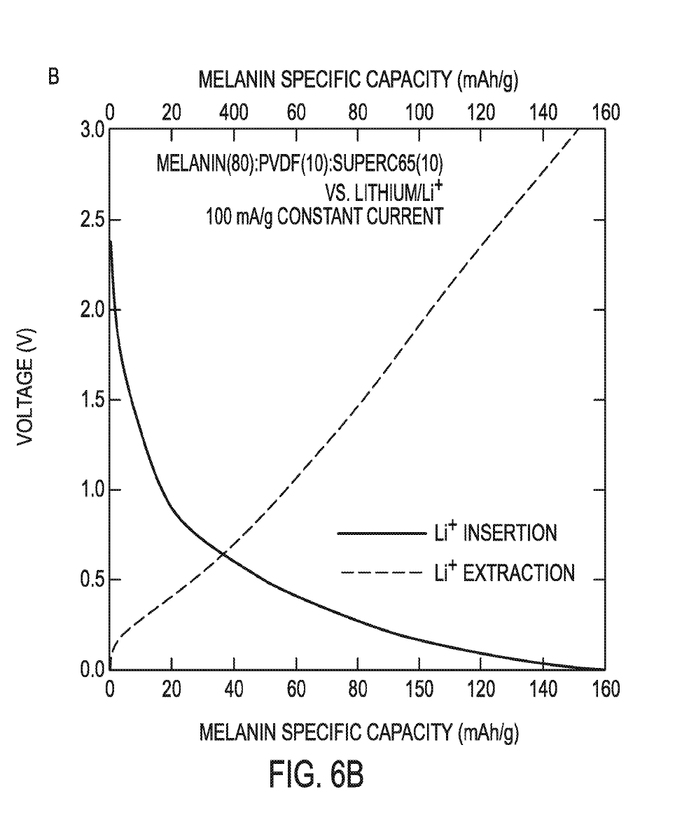

FIGS. 6A-6B show results showing the performance of a LPM lithium ion rechargeable battery in a coin cell configuration.

### 6.2 Example 2: Battery Design Evaluation

Summary

The electrochemical performance of melanin was evaluated in multiple battery designs. The melanin was produced using the methods of U.S. Pat. No. 8,815,539 B1 (Methods for Producing Melanin and Inorganic Fertilizer from Fermentation Leachates, Popa and Nealson, Aug. 26, 2014), The results of this study demonstrate the capability of melanin produced from food waste to be used as an alternative energy storage material. This study resulted in a measured melanin capacity of 192 mAh/g at a slow charge-discharge rate versus Lithium/Li+. These results compare favorably to traditional anode materials that range in capacity from 150-300 mAh/g and demonstrate that the melanin material is a viable candidate as an active anode alternative.

The inventors have demonstrated in Example 1 that Li-ion/LPM has even better performance than the Li-ion/pyomelanin disclosed in this example. Thus, using LPM rather than pyomelanin in the melanin battery designs described and evaluated below will yield even better-performing batteries.

Introduction

Melanin, a quinone polymer, can be used for constructing organic batteries or as an additive in lithium batteries to promote longevity and/or dampen runaway reactions to promote safer lithium batteries. The recycling of food waste to create these other products, including batteries, has the potential to avoid the use of metals in batteries and associated safety issues common with lithium batteries.

Study Objective

The objective of this study was to evaluate the electrochemical performance of melanin in multiple battery designs including capacity, rate capability, and cycle life of cells containing melanin materials, and comparing it to industry standard materials (i.e., lithium). A series of electrode slurries was prepared, coated, and dried for the fabrication of melanin containing battery electrodes. The electrochemical performance of the prototype batteries was evaluated and compared to standard commercial cells.

Task 1: Fabrication of a Melanin Anode as an Active Lithium Ion Storage Material

A study was performed investigating the viability of the melanin material as an energy storage material. The first task focused on determining the lithium ion specific capacity of melanin as an active material in a traditional anode composite. Three-times purified melanin material, produced using the methods of U.S. Pat. No. 8,815,539 B1, was used in the study. Anode slurries were prepared by combining the electrode materials with N-Methyl-2-pyrrolidone (NMP) and mixing in a THINKY ARE-310 planetary centrifugal mixer at 2000 rpm. The slurries were coated onto a copper foil (18 Fukuda) using a RK Control Coater 101 with an adjustable spreading blade applicator, and dried subsequently at 80′C for 1 hour. The anode slurries were mixed at a mass ratio of 80.0 wt % melanin, 10 wt % polyvinylidene fluoride (PVDF), and 10 wt % Super C65 carbon black conductive additive in NMP. The melanin material was subject to grinding in a mortar and pestle to improve uniformity in the sample. The slurry was coated at an adjustable blade height of 100 μm with a resulting coating thickness of −40 μm after drying. While most of the melanin appeared to disperse and mix into the slurry, there were some small impurities visible in the coating, which may be owing to residual impurities in the starting melanin sample. The composite electrode was vacuum dried at 100° C. before coin cell fabrication commenced. Coin cells were fabricated using routine methods known in the art.

The electrodes were galvanostatically (constant current) cycled using an Arbin BT-2000 at 25° C. in a 2032 coin cell opposite a lithium metal foil with a Celgard 2325 separator. The electrolyte was 1.2M LiPF₆ in ethylene carbonate (EC) and ethyl methyl carbonate (EMC) at a ratio of 3:7 by volume, respectively. The analysis of capacity as a function of rate was performed between 3-0.1V. The resulting specific capacity was used to establish constant current Cit rates (where t is the time for a complete charge or discharge in hours). Three coin cells were fabricated for each set of data and representative data for the batch of cells are presented below.

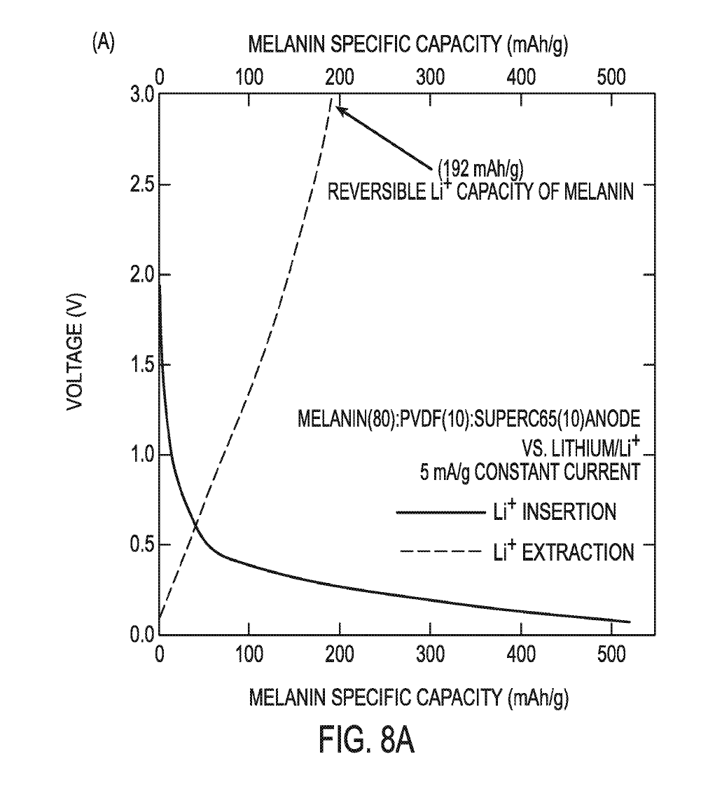

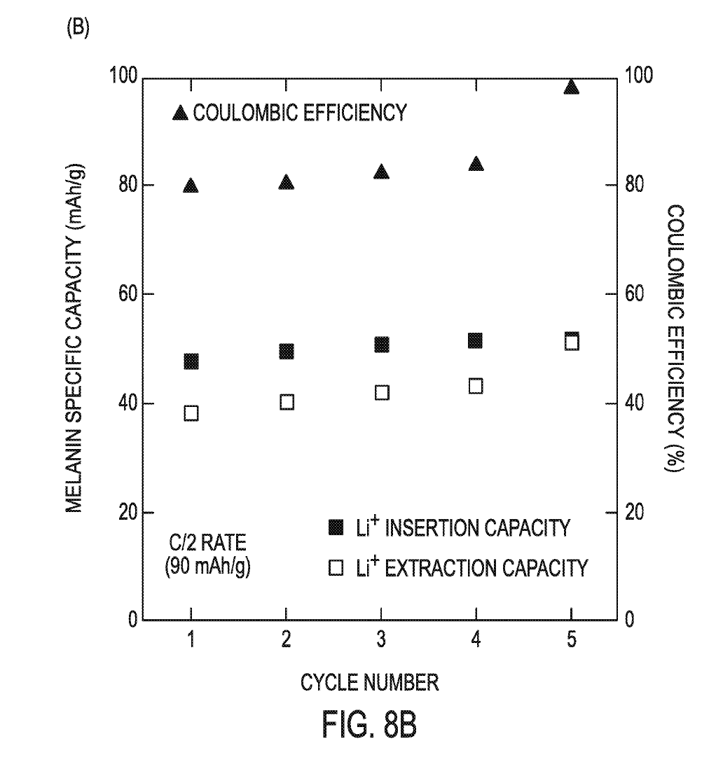

The results of the initial coin cell testing are shown in FIGS. 8A-8B with the first cycle voltage curves demonstrated in FIG. 8A. Since the exact capacity of the melanin material was not known at the start of this study, a reversible capacity of 50 mAh/g was assumed to establish the constant current rate of 5 mAh/g. However, after the initial cycle, the specific reversible capacity of melanin was found to be 192 mA/g. Therefore, this cell was subject to a low charge-discharge C-rate of C/40 (40 hour charge-40 hour discharge). It should be noted that with further cycling at the slower rates, which would require a significantly longer testing time, that the capacity may increase further as more lithium ions could become reversible and the coulombic efficiency improves with cycling. The 192 mAh/g is in the standard range of traditional anode active materials (i.e., graphitic carbons), which are typically between 150-300 mAh/g. The voltage curve for the lithium ion extraction does not have a significant voltage plateau and is sloping from 0.1-3.0V, which would give the material an average voltage of 1.5V versus Lithium/L⁺. The lithium ion insertion capacity of the melanin material at this rate was found to be 522 mAh/g. Therefore, the coulombic efficiency for the first cycle is −36%, which can be modified using routine methods when pairing the material in a full cell versus a traditional lithium metal oxide cathode.

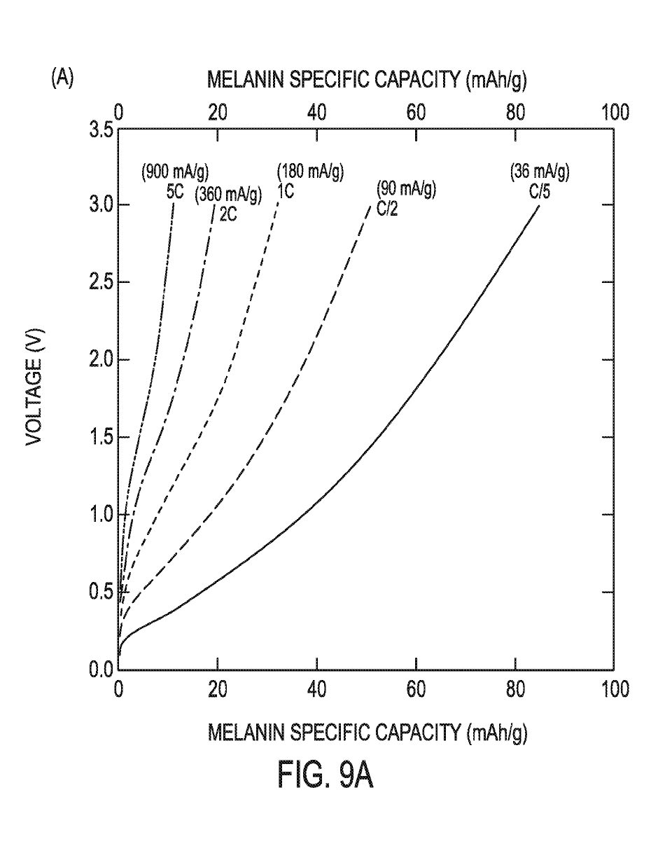

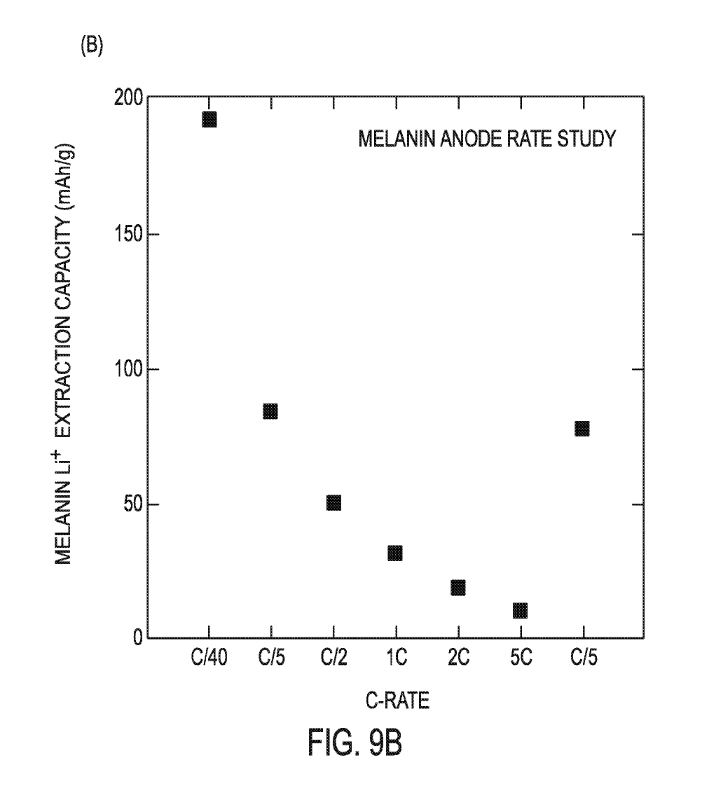

Some of the cells tested were then subject to a short-term cycling test at a C/2 rate which is shown in FIG. 8B. The first five cycles demonstrate a lower capacity of 40-50 mAh/g at this faster charge-discharge rate. However, the coulombic efficiency is improved at the faster rate, and approaches 99% after the five cycles. The rest of the fabricated cells were subject to a full rate test shown in FIGS. 9A-9B with increasing charge and discharge current C-rates of C/5 (5 hours), C/2 (2 hours), 1C (1 hour), 2C (30 minutes), and SC (12 minutes). The results demonstrate a decrease in capacity with increasing charge-discharge rates, which is typical for lithium ion active materials especially when the charge rate is increased along with the discharge rate. The capacity of the melanin anode was recoverable and returned to nearly the same capacity after the rate study finished and the current was returned to a C/5 rate. The rate capability of this material could likely be improved significantly with composite optimization through incorporation of various carbon additives, and reduction of the additional polymer binder.

As a reference, the initial melanin anode results were compared to results obtained from traditional anode materials available commercially (Table 1).

TABLE 1
Comparison of traditional anode materials
used commercially in lithium ion batteries.

| | MCMB | | Lithium | | | |
|---|---|---|---|---|---|---|
| Anode Material | (Mesocarbon | | Titanium | | | |
| Comparison | Microbeads)* | | Oxide* | | Melanin | |
| Specific Capacity | 330 | mAh/g | 170 | mAh/g | 192 | mAh/g** |
| (mAh/g) | | | | | | |
| Average Voltage | 0.1 | V | 1.5-1.7 | V | 1.5 | V |
| vs. Lithium | | | | | | |
| 2 C Discharge | 18 | mAh/g | 100 | mAh/g | 20 | mAh/g |
| Capacity (mAh/g) | | | | | | |
| SC Discharge | 5 | mAh/g | 75 | mAh/g | 11 | mAh/g |
| Capacity | | | | | | |

*Mesocarbon Microbeads (MCMB) and melanin results were measured directly. Lithium Titanium Oxide data were taken from published results (Sun et al., International Conference on NanoTechnology, Proceedings of the 141 IEEE, 2014)
**192 mAh/g was the specific capacity for melanin material in the specific formulation and after the first cycle. The capacity may improve further with increased cycling at slow rates or in different electrode formulations.

Mesocarbon microbeads (MCMB) are spherical forms of graphite that have been utilized extensively in high energy mobile lithium ion designs. The lower average voltage versus lithium and higher capacity at a low rate are advantages compared to the melanin anode. However, the capacity of the melanin anode at higher charge-discharge rates exceeds that of the MCMB anodes. Lithium Titanium Oxide (LTO) is an alternative to graphitic anodes, owing to its improved safety, and rate capability. However, the capacity and average voltage are comparable to the melanin anode.

These results demonstrate that melanin can be used as an active anode material replacement; especially when the potential low cost and sustainability attributes of melanin produced from food waste (e.g., according to the methods of U.S. Pat. No. 8,815,539 B1) is considered. Further purification and modifications to the melanin structure could yield improved electrochemical storage results that would compare to traditional anode materials.

Task 2: Fabrication of a Modified Melanin Material Anode as an Active Lithium Ion Storage Material

In Task 2, a modified melanin material was investigated that chemically incorporated lithium ions into the melanin structure. The three times purified melanin material was ground using a mortar and pestle before treatment. Lithium hydroxide was dissolved in ethanol below the solubility limit. Melanin was added to the solution and stirred for 24 hours at room temperature. Stoichiometric amounts of lithium hydroxide and melanin were added to the solution assuming a lithium capacity for the melanin of 200 mAh/g. The solution was vacuum filtered through a 1.0 μm polypropylene filter paper. The powder was then subjected to drying at 100° C. for 6 hours. The dried powder was incorporated into an anode slurry and an electrode was fabricated following the same procedure described in Task 1.

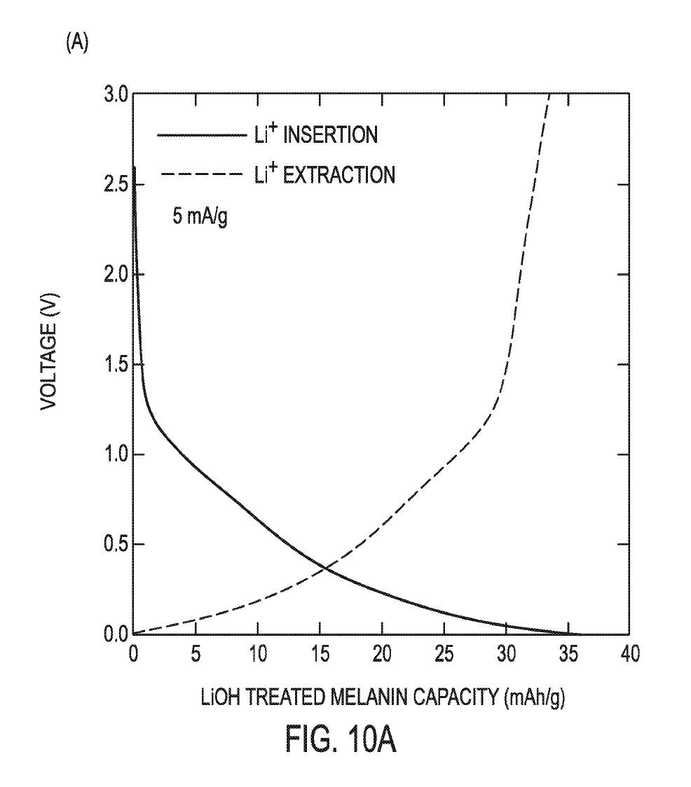

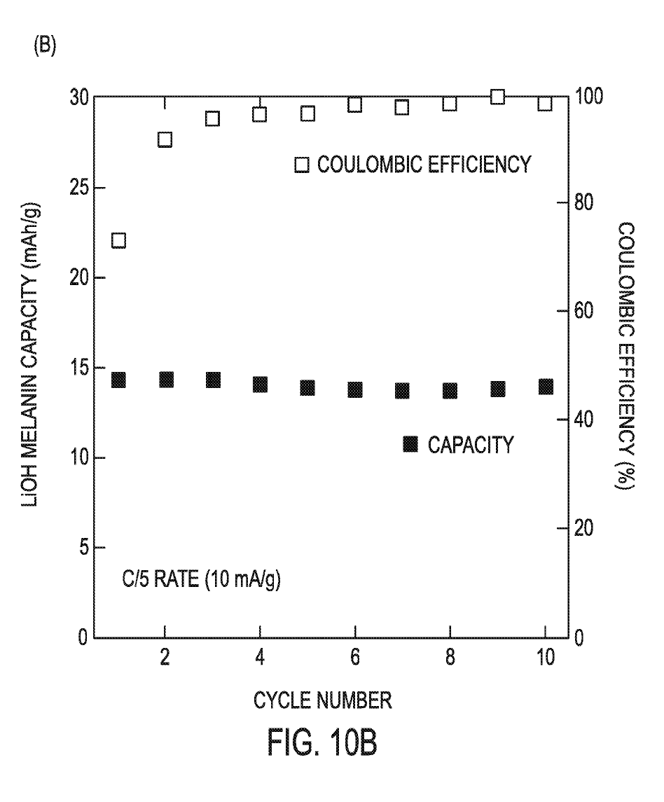

The first cycle lithium insertion-extraction voltage profiles at a current rate of 5 mA/g are shown in FIG. 10A. The results demonstrate a lower reversible capacity compared to the as-received melanin material of 33 mAh/g. However, this material does demonstrate promise to improve melanin active material performance. The average voltage versus lithium of this material is 0.65V, and has a voltage curve and plateau that is more common for lithium ion anodes. In addition, the initial coulombic efficiency is improved significantly compared to that of the as-received melanin sample. The cycling performance and coulombic efficiency of a cell cycled at a faster charge-discharge rate (C/5) is shown in FIG. 10B. The capacity does decrease with rate, but there is minimal loss in the cycling data.

Owing to the low starting capacity of this material, the rate performance was not investigated in this work. The LiOH treatment was beneficial to the average voltage and coulombic efficiency, which can allow for full utilization of the capacity when paired with a lithium metal oxide cathode. Further optimization or alternative methods to incorporating lithium into the melanin structure could lead to a balance between capacity, average voltage, and coulombic efficiency. Modified melanin demonstrates an improved voltage profile, and the ability the efficiently transport lithium ions that warrants further study as another active anode material replacement.

Task 3: Fabrication of Mesocarbon Microbeads (MCMB) with Melanin

In Task 3, melanin was incorporated into a traditional mesocarbon microbead (MCMB) anode composite as an additive to potentially improve electron transport. The three times purified melanin material was used for this study. The anode slurries were mixed at a mass ratio of 86.5 wt % MCMB, 5% melanin, 8 wt % polyvinylidene fluoride (PVDF), and 0.5 wt % Super C65 carbon black conductive additive in NMP. The melanin material was subject to grinding in a mortar and pestle to improve uniformity in the sample. A standard MCMB control composite was also fabricated at a mass ratio of 91.5 wt % MCMB, 8 wt % polyvinylidene fluoride (PVDF), and 0.5 wt % Super C65 carbon black conductive additive in NMP. Both slurries were coated at an adjustable blade height of 150 μm with a resulting coating thickness of −60 μm after drying.

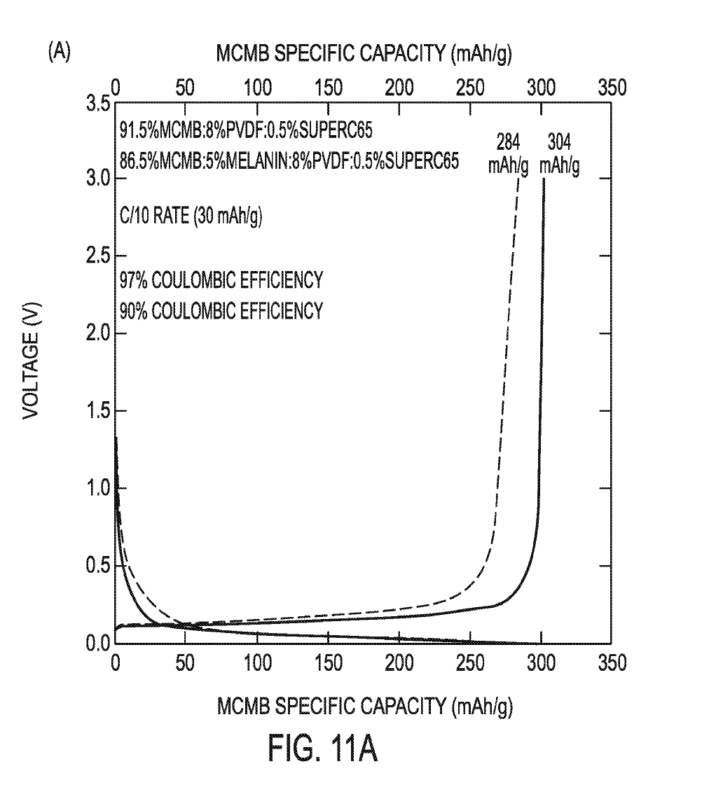

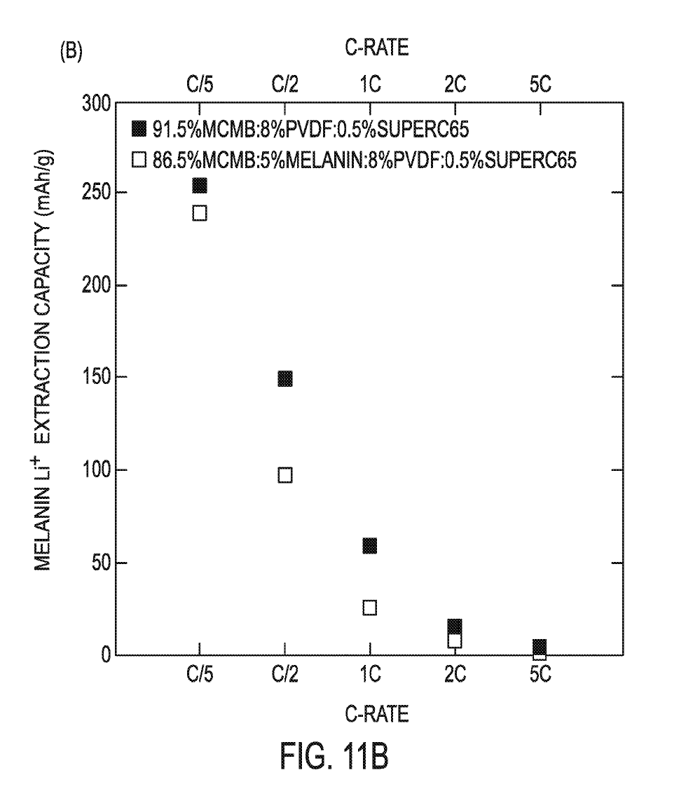

The resulting anode composites were tested versus lithium in a 2032 coin cell. The coin cells were galvanostatic (constant current) tested as a function of capacity and charge-discharge rate. The first cycle lithium ion insertion and extraction voltage curves are shown in FIG. 11A. The results demonstrate a higher capacity and coulombic efficiency for the control MCMB composite without the addition of melanin. The control composite had a specific MCMB capacity of 304 mAh/g and a coulombic efficiency of 97% compared to 284 mAh/g and 90% coulombic efficiency for the melanin added to MCMB composite sample.

The composites were tested as a function of charge-discharge c-rates at C/5 (5 hour), C/2 (2 hour), 1C (1 hour), 2C (30 minutes), and SC (12 minutes). The resulting capacity as a function of c-rate is shown in FIG. 11B. The results demonstrate a higher capacity retention at increasing charge-discharge c-rates for the control MCMB composite (black) compared to the melanin additive sample (red). These results indicate that melanin does not improve the performance of MCMB composites as a partial additive-active material replacement.

Task 4: Design and Testing of a Modified Battery Architecture-LiNiCoAlO₂ Cathode Versus Melanin Anode

In Task 4, the melanin active material anode design from Task 1 was paired with a capacity matched LiNiCoAlO₂ (NCA) cathode composite that was fabricated in a full cell design. Cathode slurries were prepared by combining the electrode materials with N-Methyl-2-pyrrolidone (NMP) and mixing in a THINKY ARE-310 planetary centrifugal mixer at 2000 rpm. The slurries were coated onto an aluminum foil (18 μm, Fukuda) using a RK Control Coater 101 with adjustable spreading blade applicator, and dried subsequently at 80° C. for 1 hour. The cathode slurry was mixed at a mass ratio of 92 wt % LiNi_{0.8}CO_{0.15}2Al_{0.05}O₂(NCA). 4 wt % KYNAR Powerflex polyvinylidene fluoride (PVDF), and 4 wt % Super C65 in NMP. The NCA composite electrode was then vacuum dried at 100° C. and compressed using a chrome coated roller (MTI) to reduce the thickness by 30-40%. The electrodes were galvanostatically cycled using an Arbin BT-2000 at 25° C. in a LiNiCoAlO2 versus the melanin anode in a 2032 coin cell configuration with a Celgard 2325 separator. The electrolyte was 1.2M LiPF₆ in ethylene carbonate (EC) and ethyl methyl carbonate (EMC) at a ratio of 3:7 by volume, respectively. The constant current testing was performed between 1.0-4.0V.

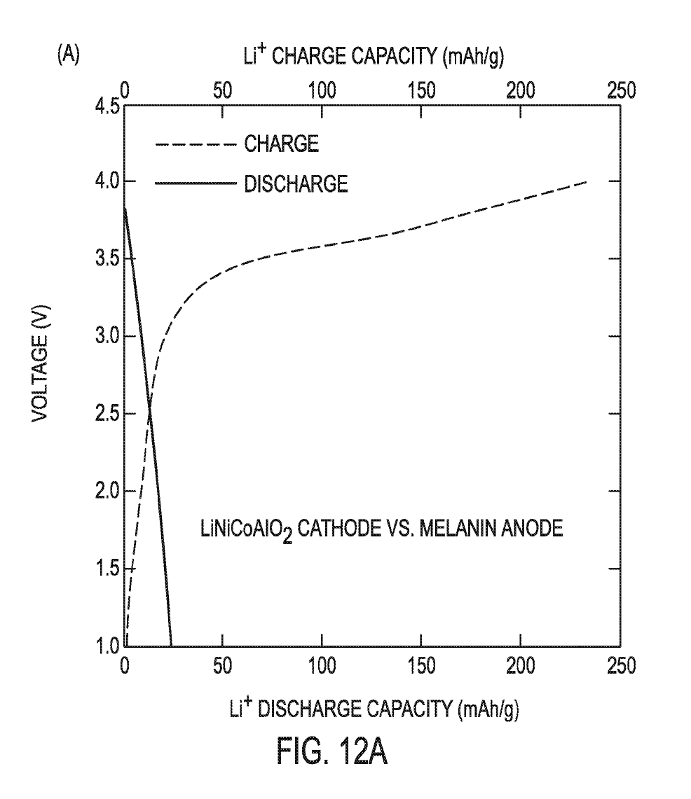

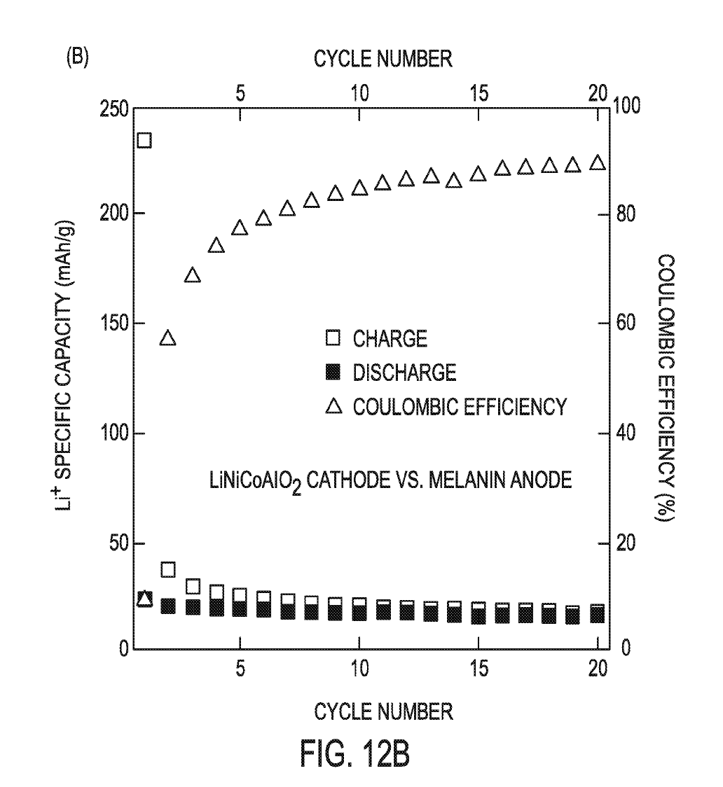

The first cycle lithium insertion-extraction voltage profiles at a current rate of 18 mA/g of NCA are shown in FIG. 12A. The capacity in FIG. 12A is shown with respect to the NCA specific capacity. A standard NCA composite versus a graphitic composite would have an expected charge capacity of −200 mAh/g and discharge capacity of −180 mAh/g. The results demonstrate a high charge capacity of 233 mAh/g, but the cell has a poor reversible capacity of 24 mAh/g. The low reversible capacity is owing to the poor coulombic efficiency of the melanin anode where lithium is being lost owing to excess solid-electrolyte-interface formation or non-reversible storage of lithium ions in the melanin polymer. The cycling performance of the full cell is demonstrated in FIG. 12B. The full cell cycles reversibly with a capacity of −20 mAh/g where the coulombic efficiency reaches 90% after the 20 cycles.

Results and Discussion

In Task 1, an anode with melanin as the active material was fabricated and tested versus lithium/Li+. The results at slow lithium insertion-extraction rates of C/40 demonstrated a reversible capacity of 192 mAh/g. This result is within the range of traditional anode materials today. However, the melanin anode had a sloping voltage curve upon extraction of lithium ions, with an average voltage of 1.5V, and a low first cycle coulombic efficiency.

In Task 2, the voltage curve and coulombic efficiency were improved by the incorporation of lithium into the melanin with chemical treatment with LiOH. The capacity of the LiOH-melanin anode was much lower at around 30 mAh/g which would need to be improved to be a viable anode alternative. In Task 3, melanin was incorporated into a MCMB anode composite as an additive and compared to a control MCMB composite. The results demonstrated a lower initial capacity, and rate performance of the melanin additive composite compared to the control. In Task 4, the melanin active material anode was paired with a capacity matched LiNiCoAlO2 (NCA) cathode in a full cell design. The full cell had a high charge specific capacity with respect to NCA, of 233 mAh/g, but had a low reversible capacity of 24 mAh/g. The low reversible capacity is owing to the high first cycle loss of lithium and poor coulombic efficiency of the melanin anode that would need to be addressed though a pre-lithiation technique.

Conclusion

The results of this study demonstrate that melanin can reversibly store lithium ions at a capacity within the range of anode materials used at present and can be used as an alternative energy storage material, owing to the potential environmental and cost benefits of the material. This study resulted in a measured melanin capacity of 192 mAh/g at a slow charge-discharge rate versus Lithium/Li+. These initial results compare favorably to traditional anode materials that range in capacity from 150-300 mAh/g. The potential low cost and sustainability of the melanin material (produced, for example, by the method of U.S. Pat. No. 8,815,539 B1) makes the melanin material a candidate as an active anode alternative in low energy dense applications.

The inventors have demonstrated in Example 1 that Li-ion/LPM has even better performance than the Li-ion/pyomelanin disclosed in this example. Thus using LPM rather than pyomelanin in the melanin battery designs described and evaluated in this example will yield even better-performing batteries.

Sample of Methods

A sample of the methods that are described herein are set forth in the following numbered paragraphs:
1. A method for producing lithiated pyomelanin (LPM) comprising:

dissolving melanin in an alkaline lithium solution or in a solution comprising a mixture comprising:

### LiOH; or

NaOH/KOH and a Li salt,
thereby producing an alkaline solution of lithium ions (Li⁺) comprising the melanin;

reducing the alkaline lithium solution comprising the melanin using a reducing agent or using a cathode of an electrochemical cell at an electrical potential ≤0.8V;

in a reducing environment and/or in an electrical potential ≤0.8V and under anaerobic conditions, titrating the alkaline lithium solution comprising the melanin to neutral pH;

in the reducing environment and/or in the electrical potential ≤0.8V and under anaerobic conditions, dialyzing the mixture relative to dH₂O, thereby producing a solution comprising LPM;

under anaerobic conditions, freezing the solution comprising LPM; and

lyophilizing the solution comprising LPM to remove water; thereby producing LPM.
2. The method of paragraph number 1 wherein the dialyzing is conducted under cold conditions.
3. The method of paragraph number 1 wherein the dialyzing is conducted using a low cutoff dialysis membrane or filter.
4. A method for producing sodiated pyomelanin (SPM) comprising:

dissolving melanin in an alkaline sodium solution or in a solution comprising a mixture comprising:

NaOH; or

KOH and a sodium salt,

thereby producing an alkaline solution of sodium ions (Na+) comprising the melanin;

reducing the alkaline sodium solution comprising the melanin using a reducing agent or using a cathode of an electrochemical cell at an electrical potential ≤0.8V;

in a reducing environment and/or in an electrical potential ≤0.8V and under anaerobic conditions, titrating the alkaline sodium solution comprising the melanin to neutral pH;

in the reducing environment and/or in the electrical potential ≤0.8V and under anaerobic conditions, dialyzing the mixture relative to dH₂O, thereby producing a solution comprising SPM;

under anaerobic conditions, freezing the solution comprising SPM; and

lyophilizing the solution comprising SPM to remove water; thereby producing SPM.
5. The method of paragraph number 4 wherein the dialyzing is conducted under cold conditions.
6. The method of paragraph number 4 wherein the dialyzing is conducted using a low cutoff dialysis membrane or filter.
7. A method for producing potassiated pyomelanin (PPM) comprising:

dissolving melanin in an alkaline potassium solution or in a solution comprising a mixture comprising:

KOH; or

NaOH and a potassium salt,

thereby producing an alkaline solution of potassium ions (K+) comprising the melanin;

reducing the alkaline potassium solution comprising the melanin using a reducing agent or using a cathode of an electrochemical cell at an electrical potential ≤0.8V;

in a reducing environment and/or in an electrical potential ≤0.8V and under anaerobic conditions, titrating the alkaline potassium solution comprising the melanin to neutral pH;

in the reducing environment and/or in the electrical potential ≤0.8V and under anaerobic conditions, dialyzing the mixture relative to dH₂O, thereby producing a solution comprising PPM;

under anaerobic conditions, freezing the solution comprising PPM; and

lyophilizing the solution comprising PPM to remove water; thereby producing PPM.
8. The method of paragraph number 7 wherein the dialyzing is conducted under cold conditions.
9. The method of paragraph number 7 wherein the dialyzing is conducted using a low cutoff dialysis membrane or filter.
10. A method for producing a battery with increased safety, wherein the battery comprises an anode(−) compartment and a cathode(+) compartment, the method comprising:

providing a battery anode mixture;

providing lithiated pyomelanin (LPM), sodiated pyomelanin (SPM) and/or potassiated pyomelanin (PPM);

providing a battery electrolyte, wherein the battery electrolyte is non-aqueous or a proton-releasing chemical; and

adding the LPM, SPM and/or PPM to the battery anode mixture, thereby producing a battery anode mixture comprising the LPM, SPM and/or PPM, wherein the battery anode mixture comprising the LPM, SPM and/or PPM is in sufficiently low abundance so that when the battery is short-circuited or demand on the battery for electricity is large, heat released during discharge of the battery is less than a specific heat capacity of the battery, thereby:

increasing safety of the battery by avoiding formation of metallic lithium (Li^{o}), sodium (Na^{o}) and/or potassium (K^{o}) in the battery,

lowering risk of overheating of the battery and/or lowering risk of explosion of the battery, and

producing a battery with increased safety.
11. The method of paragraph number 10 wherein the battery anode mixture is a carbon anode mixture.
12. The method of paragraph number 10 wherein the LPM, SPM and/or PPM is added to and/or coated on a conductive surface of the anode compartment.

The present invention is not to be limited in scope by the specific embodiments described herein. Indeed, various modifications of the invention in addition to those described herein will become apparent to those skilled in the art from the foregoing description. Such modifications are intended to fall within the scope of the appended claims.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

While embodiments of the present disclosure have been particularly shown and described with reference to certain examples and features, it will be understood by one skilled in the art that various changes in detail may be effected therein without departing from the spirit and scope of the present disclosure as defined by claims that can be supported by the written description and drawings. Further, where exemplary embodiments are described with reference to a certain number of elements it will be understood that the exemplary embodiments can be practiced utilizing either less than or more than the certain number of elements.

All references cited herein are incorporated herein by reference in their entirety and for all purposes to the same extent as if each individual publication, patent or patent application was specifically and individually indicated to be incorporated by reference in its entirety for all purposes.

The citation of any publication is for its disclosure prior to the filing date and should not be construed as an admission that the present invention is not entitled to antedate such publication by virtue of prior invention.

What is claimed is:

1. A method for producing lithiated pyomelanin (LPM) comprising:
dissolving melanin in an alkaline lithium solution or in a solution comprising a mixture comprising:
LiOH; or
NaOH/KOH and a Li salt,
thereby producing an alkaline solution of lithium ions (Li⁺) comprising the melanin;
reducing the alkaline lithium solution comprising the melanin using a reducing agent or using a cathode of an electrochemical cell at an electrical potential ≤0.8V;
in a reducing environment and/or in an electrical potential ≤0.8V and under anaerobic conditions, titrating the alkaline lithium solution comprising the melanin to neutral pH;
in the reducing environment and/or in the electrical potential ≤0.8V and under anaerobic conditions, dialyzing the mixture relative to dH₂O, thereby producing a solution comprising LPM;
under anaerobic conditions, freezing the solution comprising LPM; and
lyophilizing the solution comprising LPM to remove water; thereby producing LPM.

2. The method of claim 1 wherein the dialyzing is conducted under cold conditions.

3. The method of claim 1 wherein the dialyzing is conducted using a low cutoff dialysis membrane or filter.

4. A method for producing sodiated pyomelanin (SPM) comprising:
dissolving melanin in an alkaline sodium solution or in a solution comprising a mixture comprising:
NaOH; or
KOH and a sodium salt,
thereby producing an alkaline solution of sodium ions (Na+) comprising the melanin;
reducing the alkaline sodium solution comprising the melanin using a reducing agent or using a cathode of an electrochemical cell at an electrical potential ≤0.8V;
in a reducing environment and/or in an electrical potential ≤0.8V and under anaerobic conditions, titrating the alkaline sodium solution comprising the melanin to neutral pH;
in the reducing environment and/or in the electrical potential ≤0.8V and under anaerobic conditions, dialyzing the mixture relative to dH₂O, thereby producing a solution comprising SPM;
under anaerobic conditions, freezing the solution comprising SPM; and
lyophilizing the solution comprising SPM to remove water; thereby producing SPM.

5. The method of claim 4 wherein the dialyzing is conducted under cold conditions.

6. The method of claim 4 wherein the dialyzing is conducted using a low cutoff dialysis membrane or filter.

7. A method for producing potassiated pyomelanin (PPM) comprising:
dissolving melanin in an alkaline potassium solution or in a solution comprising a mixture comprising:
KOH; or
NaOH and a potassium salt,
thereby producing an alkaline solution of potassium ions (K+) comprising the melanin;
reducing the alkaline potassium solution comprising the melanin using a reducing agent or using a cathode of an electrochemical cell at an electrical potential ≤0.8V;
in a reducing environment and/or in an electrical potential ≤0.8V and under anaerobic conditions, titrating the alkaline potassium solution comprising the melanin to neutral pH;
in the reducing environment and/or in the electrical potential ≤0.8V and under anaerobic conditions, dialyzing the mixture relative to dH₂O, thereby producing a solution comprising PPM;
under anaerobic conditions, freezing the solution comprising PPM; and
lyophilizing the solution comprising PPM to remove water; thereby producing PPM.

8. The method of claim 7 wherein the dialyzing is conducted under cold conditions.

9. The method of claim 7 wherein the dialyzing is conducted using a low cutoff dialysis membrane or filter.

10. A method for producing a battery with increased safety, wherein the battery comprises an anode(−) compartment and a cathode(+) compartment, the method comprising:
providing a battery anode mixture;
providing lithiated pyomelanin (LPM), sodiated pyomelanin (SPM) and/or potassiated pyomelanin (PPM);
providing a battery electrolyte, wherein the battery electrolyte is non-aqueous or a proton-releasing chemical; and
adding the LPM, SPM and/or PPM to the battery anode mixture, thereby producing a battery anode mixture comprising the LPM, SPM and/or PPM, wherein the battery anode mixture comprising the LPM, SPM and/or PPM is in sufficiently low abundance so that when the battery is short-circuited or demand on the battery for electricity is large, heat released during discharge of the battery is less than a specific heat capacity of the battery, thereby:
increasing safety of the battery by avoiding formation of metallic lithium (Li^{o}), sodium (Na^{o}) and/or potassium (K^{o}) in the battery,
lowering risk of overheating of the battery and/or lowering risk of explosion of the battery, and
producing a battery with increased safety.

11. The method of claim 10 wherein the battery anode mixture is a carbon anode mixture.

12. The method of claim 10 wherein the LPM, SPM and/or PPM is added to and/or coated on a conductive surface of the anode compartment.
